(19) United States
(12) Patent Application Publication
(10) Pub. No.: US 2012/0058355 A1
(43) Pub. Date: Mar. 8, 2012

(54) Coatings

(76) Inventors: Hyomin Lee, Cambridge, MA (US); Michael F. Rubner, Westford, MA (US); Robert E. Cohen, Jamaica Plain, MA (US)

(21) Appl. No.: 13/215,869

(22) Filed: Aug. 23, 2011

Related U.S. Application Data
(63) Continuation-in-part of application No. 12/792,463, filed on Jun. 2, 2010.
(60) Provisional application No. 61/183,312, filed on Jun. 2, 2009.

(51) Int. Cl. B32B 27/08; B05D 1/38; B05D 3/02; B05D 5/00

(52) U.S. Cl. 428/515; 428/411.1; 428/500; 427/407.1; 427/385.5

(57) ABSTRACT

A hydrophilic coating can be applied to virtually any surface to produce a long-lasting, durable antifog effect. The coating can be biocompatible. The coating includes a molecular-level blend of hydrophilic polymers. The coating can be assembled using a layer-by-layer assembly process.

### CLAIM OF PRIORITY

This application is a continuation-in-part of U.S. application Ser. No. 12/792,463, filed on Jun. 2, 2010, which claims priority to provisional U.S. Patent Application No. 61/183,312, filed on Jun. 2, 2009, each of which is incorporated by reference in its entirety.

### FEDERALLY SPONSORED RESEARCH OR DEVELOPMENT

This invention was made with government support under Grant No. DMR-0819762 awarded by the National Science Foundation. The government has certain rights in this invention.

### TECHNICAL FIELD

This invention relates to coatings.

### BACKGROUND

Many substrates, whether transparent, translucent, or opaque, become fogged when a surface of the substrate is cooler than the dew point of the surrounding air—for example, when a cooled surface is exposed to moist air. Transparent substrates such as vehicle windows, airplane windshields and windows, packages for foods, plastic sheets for vegetable gardens, greenhouse windows, optical eyewear (eyeglasses, sunglasses, goggles, faceshields, etc.), binoculars, camera lenses, endoscopic lenses, and other optical instruments, are all vulnerable to fogging. Non-transparent and/or reflecting surfaces of plastics, ceramics and metals are also subject to fogging or moisture condensation on their surfaces. The fogging of optical elements such as eyeglasses and car windows can be a nuisance, or in many cases, a serious hazard. A number of different types of coatings and additives have been used to address fogging, especially of optical surfaces. Despite considerable work devoted to this problem, there remains a need for an effective, inexpensive, and durable long-lasting antifog coating that can be generally applied (i.e., without extensive customization and optimization of manufacturing conditions) to surfaces of interest. This is why very few products available today are sold with permanent antifog capability and other properties.

### SUMMARY

Polyelectrolyte multilayers can be easily assembled on a variety of surfaces. Selection of the materials, assembly conditions, and post-processing conditions can be used to control the chemical, structural and optical properties of the final product. Stable, durable coatings can be formed from layer-by-layer assembled films including polyelectrolytes. The coatings can provide durable antifogging properties or biocompatibility to surfaces, particularly optical surfaces.

A hydrophilic coating can be applied to virtually any surface to produce a long-lasting, durable antifog effect. The coating can include a molecular-level blend of at least two hydrophilic polymers. The coating can be made, for example, by a layer-by-layer assembly process, though other techniques can be used. The layer-by-layer assembly can be a water based process, thereby avoiding solvents and chemicals that can damage many plastic substrates (such as polycarbonate and poly(methyl methacrylate)) that are widely used in optical applications. The conformal coatings can be applied by, for example, a dip-, spin-, or spray-assembly process. The antifog coatings can be highly transparent and have highly effective antifogging performance under a variety of conditions. The durability of the coatings can be increased by a variety of common crosslinking and surface modification methods.

In one aspect, an article includes a surface coated with an antifog coating, the coating including a first hydrophilic polymer and a second hydrophilic polymer; where the first and second hydrophilic polymers are molecularly blended.

The coating can include a first layer including the first hydrophilic polymer, and a second layer including the second hydrophilic polymer. The first hydrophilic polymer and the second hydrophilic polymer can be intermingled. The coating can include a sequence of layers including a plurality of first layers including the first hydrophilic polymer alternating with a plurality of layers including the second hydrophilic polymer.

In another aspect, an article includes a surface coated with an antifog coating, the coating including a sequence of layers including a plurality of first layers including a first hydrophilic polymer alternating with a plurality of layers including a second hydrophilic polymer, wherein the first hydrophilic polymer and the second hydrophilic polymer are intermingled. The first layer can consist essentially of the first hydrophilic polymer. The second layer can consist essentially of the second hydrophilic polymer.

In another aspect, a method of coating a surface of an article with an antifog coating, includes depositing on the surface a composition including molecularly blended first and second hydrophilic polymers.

In another aspect, a method of coating a surface of an article includes depositing a composition including an anchoring polymer on a surface, and depositing a first hydrophilic polymer and a second hydrophilic polymer on the composition including the anchoring polymer. Depositing the composition including the anchoring polymer can include contacting the surface with a solution including the anchoring polymer.

In another aspect, the method can further include exposing the surface, prior to depositing the first hydrophilic polymer or the second hydrophilic polymer, to a predetermined temperature for a predetermined time sufficient to thermally cross-link the surface and the anchoring polymer but insufficient to deform the article. Cross-linking the surface and the anchoring polymer can include forming covalent bonds between the surface and the anchoring polymer.

In another aspect, the method including depositing the first hydrophilic polymer and the second hydrophilic polymer can further include contacting the surface with a solution including the first hydrophilic polymer. The solution including the first hydrophilic polymer can be at a pH no higher than 2.0.

In another aspect, the method can further include exposing the surface, after depositing the anchoring polymer and the first hydrophilic polymer, to a predetermined temperature for a predetermined time sufficient to thermally cross-link the anchoring polymer and the first hydrophilic polymer but insufficient to deform the article. Depositing the first hydrophilic polymer and the second hydrophilic polymer further can include contacting the surface with a solution including the second hydrophilic polymer. Depositing the composition including an anchoring polymer on a surface, and depositing the first hydrophilic polymer and the second hydrophilic polymer on the composition including the anchoring polymer can include forming an anchoring layer including the anchoring polymer, forming a first layer including the first hydrophilic polymer, and forming a second layer including the second hydrophilic polymer.

In another aspect, depositing the first hydrophilic polymer and the second hydrophilic polymer can include selecting the first hydrophilic polymer and the second hydrophilic polymer such that the first hydrophilic polymer and the second hydrophilic polymer intermingle when deposited.

In another aspect, depositing the first hydrophilic polymer and the second hydrophilic polymer can include forming an alternating sequence of layers including a plurality of first layers including the first hydrophilic polymer alternating with a plurality of second layers including the second hydrophilic polymer.

In another aspect, depositing the first hydrophilic polymer and the second hydrophilic polymer can include alternately contacting the surface with the solution including the first hydrophilic polymer and with a solution including the second hydrophilic polymer.

In another aspect, the anchoring polymer can include cross-linking groups. The cross-linking groups can be selected from the group consisting of carboxyl, epoxy, isocyanate, acrylate, vinyl, and styryl. The anchoring polymer can include poly(glycidyl methacrylate) (PGMA).

In another aspect, the first hydrophilic polymer can include a poly(vinyl alcohol) (PVA). The second hydrophilic polymer can be selected from the group consisting of poly(acrylic acid)-co-poly(ethylene oxide) copolymer (PAA-co-PEG), a poly(methacrylic acid)-co-poly(ethylene oxide) copolymer (PMAA-co-PEG), a poly(acrylic acid)-co-poly(acrylamide) copolymer (PAA-co-PAAM), a poly(methacrylic acid)-co-poly(acrylamide) (PMAA-co-PAAM), poly(acrylic acid) (PAA), poly(methacrylic acid) (PMAA), and a combination thereof.

In another aspect, contacting the surface with the solution including the anchoring polymer can include dip coating, spray coating, spin coating, or a combination thereof. Contacting the surface with the solution including the first hydrophilic polymer can include dip coating, spray coating, spin coating, or a combination thereof. Contacting the surface with the solution including the second hydrophilic polymer can include dip coating, spray coating, spin coating, or a combination thereof.

In another aspect, the coating can include a plurality of carboxylic acid groups, a plurality of hydroxyl groups, or a combination thereof. The coating can be biocompatible and anti-fogging. The method can also include attaching a functional compound to the first hydrophilic polymer or the second hydrophilic polymer.

In another aspect, an article includes a coated surface, the coating includes an anchoring layer in contact with the surface of the article, the anchoring layer including an anchoring polymer; a first layer over the anchoring layer, the first layer including a first hydrophilic polymer; and a second layer over the first layer, the second layer including a second hydrophilic polymer; wherein the coating is insoluble at physiological pH. The first hydrophilic polymer and the second hydrophilic polymer can be intermingled.

In another aspect, the coating can include an alternating sequence of layers including a plurality of layers including the first hydrophilic polymer alternating with a plurality of layers including the second hydrophilic polymer.

In another aspect, the anchoring polymer can include cross-linking groups. The cross-linking groups can be selected from the group consisting of carboxyl, epoxy, isocyanate, acrylate, vinyl, and styryl and others known in the literature. The first polymeric material can include poly(glycidyl methacrylate) (PGMA).

In another aspect, the first hydrophilic polymer can include a poly(vinyl alcohol) (PVA). The second hydrophilic polymer can be selected from the group consisting of a poly(acrylic acid)-co-poly(ethylene oxide) copolymer (PAA-co-PEG), a poly(methacrylic acid)-co-poly(ethylene oxide) copolymer (PMAA-co-PEG), a poly(acrylic acid)-co-poly(acrylamide) copolymer (PAA-co-PAAM), a poly(methacrylic acid)-co-poly(acrylamide) (PMAA-co-PAAM), poly(acrylic acid) (PAA), poly(methacrylic acid) (PMAA), and a combination thereof.

In another aspect, the surface of the article and the anchoring polymer are thermally cross-linked to one another. The thermal cross-link can include covalent bonds between the surface of the article and the anchoring polymer. The anchoring polymer and the first hydrophilic polymer can be thermally cross-linked to one another. The thermal cross-link can include covalent bonds between the anchoring polymer and the first hydrophilic polymer.

In another aspect, the first hydrophilic polymer and the second hydrophilic polymer can be thermally cross-linked to one another. The thermal cross-link can include ester linkages between the first hydrophilic polymer and the second hydrophilic polymer.

In another aspect, the coating can be biocompatible. The coating can be anti-fogging. The coating can exhibit reversible pH-dependent swelling behavior. The first hydrophilic polymer and the second hydrophilic polymer can include a plurality of carboxylic acid groups, a plurality of hydroxyl groups, or a combination thereof. The article can also include a functional compound attached to the first hydrophilic polymer or the second hydrophilic polymer.

Depositing can include contacting the surface with a first aqueous solution including the first hydrophilic polymer. Depositing can further include contacting the surface with a second aqueous solution including the second hydrophilic polymer. Depositing can include forming a first layer including the first hydrophilic polymer, and forming a second layer including the second hydrophilic polymer. Depositing can include selecting the first hydrophilic polymer and the second hydrophilic polymer such that the first hydrophilic polymer and the second hydrophilic polymer intermingle when deposited.

Depositing can include forming a sequence of layers including a plurality of first layers including the first hydrophilic polymer alternating with a plurality of layers including the second hydrophilic polymer.

Depositing can include alternately contacting the surface with a first aqueous solution including the first hydrophilic polymer and contacting the surface with a second aqueous solution including the second hydrophilic polymer.

Contacting the surface with the first aqueous solution can include dip coating, spray coating, spin coating, or a combination thereof. Contacting the surface with the second aqueous solution can include dip coating, spray coating, spin coating, or a combination thereof.

The method can further include contacting the deposited composition with a chemical cross-linking reagent. The method can further include exposing the surface to a temperature sufficient to thermally cross-link the first hydrophilic polymer and the second hydrophilic polymer but insufficient to deform the article.

In another aspect, a method of coating a surface of an article with an antifog coating, includes alternately contacting the surface with a first aqueous solution including a first hydrophilic polymer and contacting the surface with a second aqueous solution including a second hydrophilic polymer.

The first hydrophilic polymer can include a plurality of ionized or ionizable groups. The second hydrophilic polymer can include a plurality of ionized or ionizable groups. The second hydrophilic polymer can include a plurality of hydrogen bonding groups. At least one of the first and second hydrophilic polymers can be a copolymer including a first plurality of ionized or ionizable groups and a second chemically distinct plurality of hydrogen bonding groups.

The first hydrophilic polymer can be selected from the group consisting of a chitosan (CHI), a poly(allylamine)-co-poly(ethylene oxide) copolymer (PAH-g-PEG), a poly(L-lysine)-co-(polyethylene oxide) (PLL-g-PEG), a poly(quarternized-4-vinylpyridine)-co-poly(ethylene oxide) (QPVP-co-PEG), a poly(diallyldimethylammonium chloride)-co-poly(ethylene oxide) (PDADMA-co-PEG), a poly(allylamine)-co-polyacrylamide copolymer (PAH-co-PAAM), a poly(L-lysine)-co-polyacrylamide (PLL-co-PAAM), poly(quarternized-4-vinylpyridine)-co-polyacrylamide (QPVP-co-PAAM), a poly(diallyldimethylammonium chloride)-co-polyacrylamide (PDADMA-co-PAAM), a poly(allylamine)-co-polyacrylamide copolymer (PAH-co-PAAM), and a combination thereof.

The second hydrophilic polymer can be selected from the group consisting of carboxymethyl cellulose (CMC), a alginic acid (AA), a hyaluronic acid (HA), a heparin, a pectin, a poly(acrylic acid)-co-poly(ethylene oxide) copolymer (PAA-co-PEG), a poly(methacrylic acid)-co-poly(ethylene oxide) copolymer (PMAA-co-PEG), a poly(acrylic acid)-co-polyacrylamide copolymer (PAA-co-PAAM), a poly(methacrylic acid)-co-polyacrylamide (PMAA-co-PAAM), a carrageenan (κ, a 1, a λ), a fucoidan, a fucogalactan, a chondroitin, a gellan gum, a gum karaya, a gum tragacanth, a welan gum, a xanthan gum, a psyllium seed gum, and a combination thereof.

The first hydrophilic polymer can be selected from the group consisting of carboxymethyl cellulose (CMC), a alginic acid (AA), a hyaluronic acid (HA), a poly(acrylic acid)-co-poly(ethylene oxide) copolymer (PAA-co-PEG), a poly(methacrylic acid)-co-poly(ethylene oxide) copolymer (PMAA-co-PEG), a poly(acrylic acid)-co-poly(acrylamide) copolymer (PAA-co-PAAM), a poly(methacrylic acid)-co-poly(acrylamide) (PMAA-co-PAAM), and a combination thereof.

The second hydrophilic polymer can be selected from the group consisting of poly(ethylene oxide) (PEG), a polyacrylamide (PAAM), a poly(vinyl alcohol) (PVA), a poly(vinyl pyrrolidone) (PVP), a chitosan, a chitin, a inulin, a laminaran, a pullulan, a curdlan, a scleroglucan, a tara gum, a tamarind gum, a guar gum, a mannan, a dextran, a glycogen, a cellulose, and a combination thereof.

The first hydrophilic polymer and the second hydrophilic polymer can be chemically cross-linked to one another, or can be thermally cross-linked to one another. The article can be an optical component; for example, the article can be an eyewear lens. The article can be transparent, and have a relative transmittance (Tᵣ) of greater than 90% after being exposed to 100% humidity at 23° C. for at least 60 seconds. The article can be transparent, and have a haze of less than 1.0% after being exposed to 100% humidity at 23° C. for at least 60 seconds.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a schematic drawing of a coated article.

FIG. 2 is a graph depicting thicknesses of (CHI/CMC) coatings as a function of number of bilayers.

FIG. 3 is a graph depicting thicknesses of (CHI/PAA-g-PEG) coatings as a function of number of bilayers.

FIG. 4 is a topographical AFM image of a crosslinked 10 bilayers CHI/CMC coating on a glass substrate.

FIGS. 5A-5D are photographs depicting results of a humid chamber test for antifog coatings. Crosslinked 10-bilayer CHI/CMC coatings on polycarbonate were exposed to at 80% humidity at 37° C. for (A) 1 second; (B) 10 seconds; (C) 20 seconds; and (D) 60 seconds. Fogged region at the bottom of the substrate is not coated.

FIGS. 6A-6B are photographs depicting results of a humid chamber test for antifog coatings. 10-bilayer CHI/PAA-g-PEG (37% PEG) coatings were exposed to 80% humidity at 37° C. for (A) 1 second; and (B) 20 seconds. Fogged region at the bottom of the substrate is not coated.

FIGS. 7A-7B are photographs depicting results of a humid chamber test for antifog coatings. 10-bilayer CHI/PAA-g-PEG (25% PEG) coatings were exposed to 80% humidity at 37° C. for (A) 1 second; and (B) 20 seconds.

FIGS. 8A-8B are photographs depicting results of a humid chamber test for coatings. A CMC monolayer coating was exposed to 80% humidity at 37° C. for (A) 1 second; and (B) 20 seconds.

FIGS. 9A-9B are photographs depicting results of a humid chamber test for coatings. A PAA-g-PEG (50% PEG) monolayer coating was exposed to 80% humidity at 37° C. for (A) 1 second; and (B) 20 seconds.

FIG. 10 is a photograph depicting a pair of safety goggles where one lens (to the left) was coated with 10 bilayers of CHI/PAA-g-PEG (50% PEG) and one lens (to the right) was untreated. The photograph was taken after the goggles were placed in the refrigerator (4° C.) for one month.

FIG. 11 is a photograph depicting a glass substrate coated at one end (to the right) with CHI/PAA-g-PEG (50% PEG) and uncoated at the other end (to the left). The glass was substrate was directly exposed to hot steam after being placed in refrigerator at 4° C. for two weeks.

FIG. 12 is a photograph depicting a glass substrate coated at one end (to the right) with CHI/PAA-g-PEG (37% PEG) and uncoated at the other end (to the left). The glass was substrate was directly exposed to hot steam after being placed in refrigerator at 4° C. for two weeks.

FIGS. 13A-13C are micrographs of 15 bilayer coatings of CHI/PAA-g-PEG (37% PEG) after pencil hardness tests: (A), 2H; (B), 4H; and (C), 7H.

FIG. 14 is an optical image of a 15.5 bilayer coating of CMC/CHI cross-linked with both EDC/NHS and glutaraldehyde after being tested with 4H (lower) and 7H (upper) pencils.

FIG. 15A is a drawing showing interpolymer complexation of PVA and PAA; (B) is a pH/PVA matrix showing the attenuation of transmitted light (I) expressed as ΔI/Iₒ where ΔI=Iₒ−I and Iₒ is the incident light intensity; (C) are photographs of PVA/PAA and PVA/PMAA mixtures.

FIG. 16 is a pH/PVA matrix showing the attenuation of transmitted light (I) expressed as ΔI/Iₒ where ΔI=Iₒ−I and Iₒ is the incident light intensity to determine whether PVA and PMAA form water-insoluble complexes.

FIG. 17A-B are AFM images from two perspectives of the (PVA_{P3}/PAA)₃₀ film on a PGMA-anchored glass substrate showing roughness (Rₐ: 0.148 nm, R_{q}: 0.186 nm) for a ˜1.5 μm thick film. Scale bars are from +10 nm/−10 nm.

FIG. 18 is a graph showing the growth behavior of (PVA_{P1}/PAA)(-▪- squares), (PVA_{P2}/PAA) (-- circles), (PVA_{P3}/PAA) (-▴- triangles), (PVA_{F1}/PAA) (-▾- triangles), and (PVA_{F2}/PAA) ( [symbol] triangles) systems assembled at pH 2.0 on glass substrates modified with PGMA.

FIG. 19 is a graph showing the growth behavior of (PVA_{P1}/PMAA) (-▪- squares), (PVA_{P3}/PMAA) (-- circles), (PVA_{F1}/PMAA) (-▴- triangles), and (PVA_{F2}/PMAA) (-▾- triangles) systems assembled at pH 2.0 on glass substrates modified with PGMA.

FIG. 20 is a graph showing pH-triggered disintegration of hydrogen-bonded systems without any post-treatment: (PVA_{P3}/PAA) (-▪- squares), (PVA_{P2}/PMAA) (-- circles), (PVA_{P3}/PMAA₁₀₀ₖ) (-▴- triangles).

FIG. 21 is a graph of pH-triggered dissolution of untreated hydrogen bonded thin films: (PVA_{P3}/PAA)₃₀ (-▪- squares), (PVA_{P2}/PAA)₃₀ (-- circles).

FIG. 22A-B are photographs of a free-standing film of (PVA_{P3}/PAA)₁₀₀ assembled at pH 2.0 (A) on a substrate and (B) peeled off of a Teflon substrate.

FIG. 23A-D are ¹H-NMR spectra in D₂O of (A) PVA_{F2}, (B) PVA_{P3}, (C) PAA, and (D) (PVA_{P3}/PAA)₁₀₀.

FIG. 24 is a graph of the pH-triggered disintegration of hydrogen-bonded (PVA_{P3}/PAA)₃₀ film after heat-induced esterification. Subjecting the film to heat-treatment allows control of the disintegration pH. The images shown at right are the photograph and optical microscopy images of the film after immersion in pH 6.0 DI water for 2 hrs and drying with N₂.

FIG. 25A-D are (A) IR spectra for a series of (PVA_{P3}/PAA)₃₀ films on ZnSe substrates subjected to various heat treatment protocols; (B) A close up of the anhydride peak (1805 cm⁻¹) which only appears for the sample treated for 45 min at 150° C.; (C) and (D) Multi-peak fitting using two Gaussian functions. Heat treatment increases the area of the carboxyl peak (C|O) assigned to the acetate and ester.

FIG. 26A-C are IR spectra for (A) PVA_{F2}, (B) PVA_{P3}, and (C) PAA dip-coated films on ZnSe substrates.

FIG. 27A-B are graphs showing swelling experiments using in-situ ellipsometry measurements of (PVA_{P3}/PAA)₃₀ films to verify the effect of thermal cross-linking. a) pH 2.0 DI water, b) pH 7.4 PBS buffer.

FIG. 28A is a graph of the pH-dependent reversible swelling behavior of a (PVA_{P3}/PAA)₃₀ film heated for 5 min at 140° C. in pH 2.0 DI water and pH 7.4 PBS. Films were immersed in the solution for 10 min and dried with N₂. (B) is a drawing showing a pH-dependent reversible swelling.

FIG. 29 is a photograph of the methylene blue adsorption test to verify the presence of ionized carboxylic acid groups in a (PVA_{P3}/PAA)₃₀ film treated for 5 min at 140° C.

FIG. 30A shows a scheme of a film being functionalized with FITC-BSA and RB-PEG. Upper-right hand corner shows the emission spectra of three individual samples excited at a single wavelength of 440 nm (1: FITC-BSA only, 2: RB-PEG only, 3: both). FIG. 30B is a confocal microscopy image of the film functionalized with both FITC-BSA and RB-PEG. The excitation wavelengths were 488 nm and 543 nm.

FIG. 31A-B are graphs showing emission spectra of films coated with either FITC or RB. FIG. 31A is a comparison study of FITC and its control. Both samples were soaked in 0.1% (v/v) Tween-20 PBS (pH 6.0) for 3 hr on a shaker plate set at 100 rpm. The films were excited at 440 nm. FIG. 31B is a comparison study of RB and its control. Both samples were soaked in 0.1% (v/v) Tween-20 PBS (pH 6.0) for 15 hr on a shaker plate set at 100 rpm. Films were excited at 520 nm.

FIG. 32 is a graph showing the growth behavior of (PVAF1/PAA) (-▪- squares), (PVAF2/PAA)(-- circles), (PVAP1/PAA) (-▴- triangles), (PVAP3/PAA) (-▾- triangles) systems assembled at pH 2.0 on glass substrates modified with PGMA using a Spray LbL technique

FIG. 33A-C are photographs of the boiling water steam test on (A) (PVA/PAA)₃₀ X-linked sample; (B) (PVA/PAA)₃₀ PEG-OH X-linked sample; and (C) (PVA/PAA)₃₀ f-PEG-OH X-linked sample.

### DETAILED DESCRIPTION

Coatings having desirable antifog properties can be achieved by molecular level blending of at least two hydrophilic polymers. The hydrophilic polymers can have a high concentration of hydrophilic functional groups, such as, for example, carboxylic acid, amino, alkyl ether, and hydroxyl groups, to name a few. The hydrophilic polymers can include one or more polyelectrolytes (e.g., polycations, polyanions, or polymers including both cationic and anionic groups), one or more neutral hydrophilic polymers (e.g., polyalkylene ethers, polyacrylamides, polyols), or a combination of one or more polyelectrolytes and one or more neutral hydrophilic polymers. The antifog coatings can have hydrogen bonding interactions between hydrophilic polyelectrolytes and neutral hydrophilic polymers. Neutral and charged polysaccharides can be used in the antifog coatings.

Molecularly blended polymers can have an intermixed structure on the molecular level when blended or combined. In some cases, two polymers may each be separately soluble in water, but simply mixing the solutions results in uncontrolled precipitation of both. These uncontrolled precipitates are often not well mixed on the molecular level. In contrast, a sequence of polymer layers, as may be obtained via layer-by-layer assembly, is intermixed and interpenetrated on the molecular level. The polymers in this sequence can be referred to as molecularly blended.

Porosity, texture, and the chemical nature of the surface can influence the wetting properties of surfaces. See, for example, U.S. Patent Application Publication Nos. 2003/0215626, 2006/0029634, 2007/0104922, 2007/0166513, 2008/0268229, provisional U.S. Patent Application No. 61/061,806, and International Patent Application Publication WO 2009/009185, each of which is incorporated by reference in its entirety. Depending on the structure and chemical composition of a surface, the surface can be hydrophilic, hydrophobic, or at the extremes, superhydrophilic or superhydrophobic. One method to create the desired texture is with a polyelectrolyte multilayer. Polymer multilayers (including, for example, polyelectrolyte multilayers) can provide a surface with predetermined chemical and structural features so as to confer desired wetting and optical properties to surfaces.

Hydrophilic surfaces attract water; hydrophobic surfaces, by comparison, have energetically unfavorable interactions with water. These relatively unfavorable interactions result in familiar characteristics of hydrophobic surfaces, such as the beading and rolling of rainwater that lands on the hood of a recently waxed car. In general, a non-hydrophobic surface can be made hydrophobic by coating the surface with a hydrophobic material. The hydrophobicity of a surface can be measured, for example, by determining the contact angle of a drop of water on the surface. The contact angle can be a static contact angle or dynamic contact angle. A dynamic contact angle measurement can include determining an advancing contact angle or a receding contact angle, or both. A hydrophobic surface having a small difference between advancing and receding contact angles (i.e., low contact angle hysteresis) can be desirable. Water droplets travel across a surface having low contact angle hysteresis more readily than across a surface having a high contact angle hysteresis.

Layer-by-layer processing of polymer multilayers can be used to make conformal thin film coatings with molecular level control over film thickness and chemistry. Charged polyelectrolytes can be assembled in a layer-by-layer fashion. In other words, positively- and negatively-charged polyelectrolytes can be alternately deposited on a substrate. In some cases, an electrostatically neutral hydrophilic polymer can be substituted for a polyelectrolyte.

A hydrophilic polymer can include a plurality of ionized or ionizable functional groups. A polyelectrolyte can be polycationic or polyanionic. A polycation has a backbone with a plurality of positively charged functional groups attached to the backbone, for example, poly(allylamine hydrochloride). A polyanion has a backbone with a plurality of negatively charged functional groups attached to the backbone, such as sulfonated polystyrene (SPS) or poly(acrylic acid), or a salt thereof. Some polyelectrolytes can lose their charge (i.e., become electrically neutral) depending on conditions such as pH.

The ionization state of the ionized or ionizable functional groups may depend strongly on pH. For example, a polyelectrolyte can include functional groups that can exist as an acid/conjugate base pair, such as —COON/—COO⁻, or as a base/conjugate acid pair, for example, —NH₂/—NH₃⁺. The pKₐ of an ionized or ionizable functional group can be in the range of, for example, 2 to 12, 3 to 11, or 4 to 10. Some ionized functional groups maintain an electrostatic charge largely independently of pH. For example, a quaternary amine functional group (e.g., —NR₃⁺) can be positively charged with relatively little influence from pH.

A hydrophilic polymer can include a plurality of hydrogen bonding (or H-bonding) functional groups. Generally, hydrogen bonding functional groups can be either H-bond acceptors (e.g., a lone pair of electrons; a carbonyl oxygen is frequently an H-bond acceptor) or H-bond donors. H-bond donor functional groups are typically characterized by the presence of water-exchangeable hydrogen atom; for example, a hydroxyl group includes a water exchangeable hydrogen atom and can frequently participate in a hydrogen bond as an H-bond donor. The hydroxyl group can become ionized under sufficiently basic conditions; however, most organic hydroxyl groups will be neutral in most aqueous solutions. An aqueous solution can be a solution that is composed of at least 50% water. For example, a functional group can be considered a hydrogen bonding group, but not an ionized or ionizable group, when it has a pKₐ outside the range of, e.g., 2 to 12, 3 to 11, or 4 to 10. Some functional groups, such as amino groups, can be considered as both hydrogen bonding and ionized or ionizable.

Some polymers can include multiple different ionized or ionizable or hydrogen bonding functional groups. One such example is poly-L-lysine, includes multiple amino groups (ionized or ionizable) and multiple peptide bonds (include H-bond donors and acceptors). Another example is chitosan, poly(beta-1,4-D-glucosamine), which includes multiple hydroxyl groups and multiple amino groups. A copolymer can also include different monomer units, some of which include hydrophilic functional groups and some of which include ionized or ionizable functional groups; these ionized or ionizable functional groups can be cationic or anionic, or the copolymer can include both cationic and anionic monomer units. Some examples of copolymers including both hydrogen bonding functional groups and ionized or ionizable functional groups include poly(L-lysine)-co-(polyethylene oxide)(PLL-g-PEG), poly(quarternized-4-vinylpyridine)-co-poly(ethylene oxide)(QPVP-co-PEG), poly(acrylic acid)-co-poly(ethylene oxide) copolymer (PAA-co-PEG), and poly(acrylic acid)-co-polyacrylamide copolymer (PAA-co-PAAM). The copolymers can be, for example, random copolymers, block copolymers, graft copolymers, or other copolymer.

One method of depositing the polymers is to contact the substrate with an aqueous solution of the polymer at an appropriate pH. The pH can be chosen such that a polyelectrolyte is partially or weakly charged. The multilayer can be described by the number of bilayers it includes, a bilayer resulting from the sequential application of two different polymers, e.g., two oppositely charged polyelectrolytes. For example, a multilayer having the sequence of layers PAH-PAA-PAH-PAA-PAH-PAA would be said to be made of three bilayers.

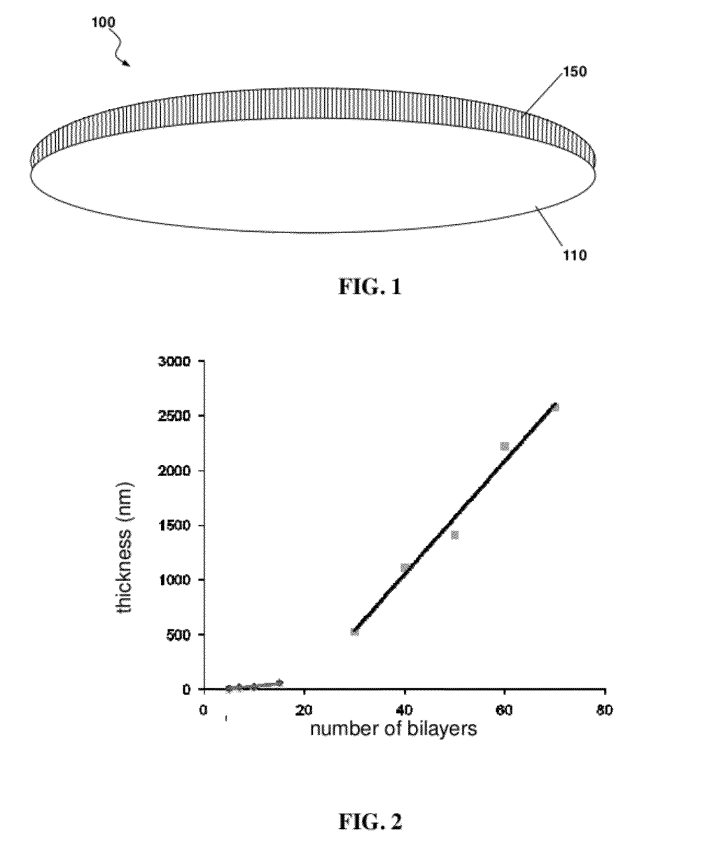

FIG. 1A schematically shows article 100 having a hydrophilic coating 150 on a surface of substrate 110. Coating 150 can include molecularly blended hydrophilic polymers. When hydrophilic polymers are deposited on the surface in a layer-by-layer process, the resulting layers may become highly interpenetrated. For example, the hydrophilic polymers of one layer may intermingle with hydrophilic polymers of a second (chemically distinct) layer. In some circumstances, the intermingling or interpenetrating may occur to an extent such that boundaries between layers are indistinct.

These methods can provide molecular control over the deposition process by simple adjustments to the conditions (e.g., pH, ionic strength, and temperature) of the processing solutions. The properties of weakly charged polyelectrolytes can be precisely controlled by changes in pH. See, for example, G. Decher, Science 1997, 277, 1232; Mendelsohn et al., Langmuir 2000, 16, 5017; Fery et al., Langmuir 2001, 17, 3779; Shiratori et al., Macromolecules 2000, 33, 4213; and U.S. Patent Application Publication No. 2003/0215626, each of which is incorporated by reference in its entirety. A coating of this type can be applied to any surface amenable to the water based layer-by-layer (LbL) adsorption process used to construct these polyelectrolyte multilayers. Because the water based process can deposit hydrophilic polymers wherever the aqueous solution contacts a surface, even the inside surfaces of objects having a complex topology can be coated. In general, a hydrophilic polymer can be applied to a surface by any method amenable to applying an aqueous solution to a surface, such as dipping or spraying.

Broadband antireflectivity can be attained using an inexpensive, simple process employing aqueous solutions of polymers. See, for example, U.S. Patent Application Publication No. 2003/0215626, which is incorporated by reference in its entirety. The process can be used to apply a high-efficiency conformal antireflective coating to virtually any surface of arbitrary shape, size, or material. The process can be used to apply the antireflective coating to more than one surface at a time and can produce coatings that are substantially free of pinholes and defects, which can degrade coating performance. The porous polymeric material can be antireflective. The process can be used to form antireflective and antiglare coatings on polymeric substrates. The simple and highly versatile process can create molecular-level engineered conformal thin films that function as low-cost, high-performance antireflection and antiglare coatings. The method can uniformly coat both sides of a substrate at once to produce defect and pinhole-free transparent coatings. The process can be used to produce high-performance polymeric optical components, including flat panel displays and solar cells.

An optical component has a function in controlling UV, visible, or IR light, where uncontrolled alteration of light (e.g., by absorption, scattering, poor focus, haze, or other uncontrolled effects) is undesired. For example, a lens (such as may be found in eyeglasses, sunglasses, cameras, binoculars, telescopes, microscopes, protective eyewear generally, e.g., safety goggles for use in labs, shops; face shields; safety goggles for use in sports (racquetball, skiing)) is an optical component. Other items that can be considered optical components include windows (e.g., exterior windows of a building or vehicle; or interior windows such as for a cold room, walk-in refrigerator or freezer), or any transparent item for which the ability to see through clearly is desirable. Additional examples include display screens (television screens, computer monitors, small LCD displays like those on a digital watch or mobile phone), glass in a photo frame, or the outer surface of mirror glass.

The polymer coating can be an antifogging coating. The antifogging coating can prevent condensation of light-scattering water droplets on a surface. By preventing the formation of light-scattering water droplets on the surface, the coating can help maintain optical clarity of a transparent surface, e.g., a window or display screen. In some cases, an antifogging coating can also be antireflective (see, e.g., U.S. Patent Application Publication No. 2007/0104922, which is incorporated by reference in its entirety). A surface of a transparent object having the antifogging coating maintains its transparency to visible light when compared to the same object without the antifogging coating under conditions that cause water condensation on the surface. Effectiveness of an antifogging coating can be assessed, for example, by visual inspection; by measurement of relative transmittance in fogging and non-fogging conditions; or by measurement of “haze”, the effect created when light is scattered upon passing through a film or sheet of a material when viewing objects through the material. ASTM D1003-07e1 (which is incorporated by reference in its entirety) details a standard test method for haze and luminous transmittance of transparent plastics; EN 167 and 168 (which are also incorporated by reference in their entirety) also describe methods for testing transmittance and variations in transmittance in the context of protective eyewear.

A lock-in or crosslinking step can enhance the durability of the coating. The lock-in can be achieved by, for example, exposure of the coating to chemical or thermal polymerization conditions. The hydrophilic polymers can become crosslinked and thereby less susceptible to mechanical damage. In some cases, chemical crosslinking step can include treatment of a polymeric coating with a carbodiimide reagent. The carbodiimide can promote the formation of crosslinks between carboxylate and amine groups of the polyelectrolytes. In some cases, chemical crosslinking step can include treatment of a polymeric coating with an aldehyde reagent. The aldehyde reagent can be a dialdehyde such as glutaraldehyde. A chemical crosslinking step can be preferred when the coating is formed on a substrate that is unstable at temperatures required for crosslinking (such as, for example, when the substrate is a plastic that would deform at the temperatures required for crosslinking). The crosslinking step can be a photocrosslinking step. The photocrosslinking can use a sensitizer (e.g., a light-sensitive group) and exposure to light (such as UV, visible or IR light) to achieve crosslinking. Masks can be used to form a pattern of crosslinked and non-crosslinked regions on a surface. Other methods for crosslinking polymer chains are known.

A partial list of hydrophilic polymers suitable for creating permanent anti-fog coatings is given in Table 1. In general, a combination of one or more polycations from among those listed in Table 1, and one or more polyanions from among those listed in Table 1, can be molecularly blended. Some such combinations are specified in the Examples below.

TABLE 1

| Polycations | Polyanions |
|---|---|
| chitosan (CHI); poly(allylamine)- | carboxymethyl cellulose (CMC); |
| co-poly(ethylene oxide) copolymer | alginic acid (AA); hyaluronic |
| (PAH-g-PEG); poly(L-lysine)- | Acid (HA); heparin; pectin; |
| co-(polyethylene oxide) | poly(acrylic acid)-co-poly(ethylene |
| (PLL-g-PEG); poly(quarternized- | oxide) copolymer (PAA- |
| 4-vinylpyridine)-co-poly(ethylene | co-PEG); poly(methacrylic |
| oxide) (QPVP-co-PEG); | acid)-co-poly(ethylene |
| poly(diallyldimethylammonium | oxide); poly(acrylic acid)- |
| chloride)-co-poly(ethylene | co-polyacrylamide copolymer |
| oxide) (PDADMA-co-PEG); | (PAA-co-PAAM); |
| poly(allylamine)-co-polyacrylamide | poly(methacrylic acid)-co- |
| copolymer (PAH-co-PAAM); | polyacrylamide (PMAA- |
| poly(L-lysine)-co-polyacrylamide | co-PAAM); carrageenan |
| (PLL-co-PAAM); poly(quarternized- | (κ, l, λ); fucoidan; fucogalactan; |
| 4-vinylpyridine)-co-polyacrylamide- | chondroitin; gellan gum; gum |
| (QPVP-co-PAAM); | karaya; gum tragacanth; welan |
| poly(diallyldimethylammonium | gum; xanthan gum; psyllium |
| chloride)-co-polyacrylamide | seed gum |
| (PDADMA-co-PAAM); | |
| poly(allylamine)-co- | |
| polyacrylamide copolymer | |
| (PAH-co-PAAM) | |

A partial list of hydrophilic polymers suitable for creating permanent anti-fog coatings is given in Table 2. In general, a combination of one or more polyanions from among those listed in Table 2, and one or more neutral polymers from among those listed in Table 2, can be molecularly blended. Some such combinations are specified in the Examples below.

TABLE 2

| Polyanions | Neutral polymers |
|---|---|
| carboxymethyl cellulose (CMC); alginic | poly(ethylene oxide) (PEG); |
| acid (AA); hyaluronic acid (HA); | polyacrylamide (PAAM); |
| poly(acrylic acid)-co-poly(ethylene | poly(vinyl alcohol) (PVA); |
| oxide) copolymer (PAA-co-PEG); | poly(vinyl pyrrolidone) (PVP); |
| poly(methacrylic acid)-co-poly(ethylene | chitosan; chitin; inulin; |
| oxide) (PMAA-co-PEG); poly(acrylic | laminaran; pullulan; curdlan; |
| acid)-co-poly(acrylamide) copolymer | scleroglucan; tara gum; |
| (PAA-co-PAAM); poly(methacrylic | tamarind gum; guar gum; |
| acid)-co-poly(acrylamide) (PMAA-co- | mannan; dextran; glycogen; |
| PAAM); poly(acrylic acid) (PAA); | cellulose |
| poly(methacrylic acid) (PMAA) | |

Poly(vinyl alcohol) (PVA) is a nontoxic, water soluble, biodegradable, and biocompatible polymer with excellent chemical resistance and physical properties. PVA is a common hydrophilic polymer that has been used broadly in the hydrogel area because of its biocompatibility and low toxicity. PVA is employed in a wide range of biomedical applications including controlled release systems, arthroplasty, and tissue engineering. See, for example, Lee, C.; et al. Arch. Pharmacal Res. 1993, 16, 43-49 and Fujie, T.; et al. Advanced Functional Materials 2009, 19, 2560-2568, each of which is incorporated by reference in its entirety. However, it dissolves in water at physiological pH which limits its utilization in in vivo applications. To avoid this problem, one normally chemically cross-links PVA with bifunctional compounds capable of reacting with hydroxyl groups to impart dissolution resistance and to improve the mechanical properties. One can achieve similar results by taking advantage of the tendency of PVA to crystallize due to the fact that its pendant hydroxyl groups are small enough to fit into the crystal lattice without disrupting it. Heating above the glass transition temperature, as well as repeated freeze-thaw cycles, are methods of increasing the crystallinity of the polymer, which acts as a physical network thereby enhancing dissolution resistance and mechanical properties. See, for example, Hasimi, A.; et al. European Polymer Journal 2008, 44, 4098-4107, which is incorporated by reference in its entirety. Conventional solvent-casting method is widely used in preparing interpenetrating polymer network (IPN) and hydrogel systems along with the post treatment mentioned so far. However, relying on solvent-casting of PVA-based films limits the applications to those where precise tuning of properties (such as responsiveness and functionality, etc.) is not necessary. To satisfy these needs, there have been a number of attempts to incorporate PVA into a polymer multilayer using LbL assembly which is a simple and versatile method where one can prepare thin, finely structured films. See, for example, Decher, G. Science 1997, 277, 1232-1237; Stockton, W. B.; Rubner, M. F. Macromolecules 1997, 30, 2717-2725; Podsiadlo, P.; et al. Science 2007, 318, 80-83; Serizawa, T.; et al. Langmuir 2002, 18, 8381-8385; and K, J.; Hsu, S. L.; McCarthy, T. J. Langmuir 2007, 23, 3260-3264, each of which is incorporated by reference in its entirety. Nevertheless, in these studies the utility of PVA was limited either by a strongly interacting polymer pair or by the fact that deposition is driven by the crystallization of PVA on hydrophobic surfaces.

Although Rubner and Sukhishvili have previously predicted that PVA would act very similarly to poly(ethylene oxide) (PEO) which others have studied in detail, little progress has been made in terms of incorporating PVA into a hydrogen bonded multilayer. See, for example, Stockton, W. B.; Rubner, M. F. Macromolecules 1997, 30, 2717-2725 and Sukhishvili, S. A.; Granick, S. Journal of the American Chemical Society 2000, 122, 9550-9551, each of which is incorporated by reference in its entirety. Hydrogen bonded LbL films composed of PVA and PAA have been made and the degree of hydrolysis of PVA has a profound effect on the intermolecular hydrogen bonding interactions with PAA, and consequently on the film properties. Polymer complexes can be formed when PVA is paired with PAA and with poly(methacrylic acid) (PMAA). Exposure to increased pH levels affects the degree of hydrolysis, and hence the dissolution of hydrogen-bonded multilayers composed of neutral polymers and polycarboxylic acids. See, for example, Kharlampieva, E.; Sukhishvili, S. A. 2006, 46, 377-395, which is incorporated by reference in its entirety.

In many applications, it is desirable for hydrogen-bonded LbL films that respond to external stimuli to be stable at physiological pH. Previous studies have focused either on choosing from a variety of hydrogen-bonding pairs to tune the critical pH of dissolution (pH_{crit}) or cross-linking the film to pH stabilize it. See, for example, Kharlampieva, E.; Sukhishvili, S. A. 2006, 46, 377-395, which is incorporated by reference in its entirety. However, when conventional neutral polymers such as PEO are assembled with polycarboxylic acids, the cross-linking induces either a single-component hydrogel by slow leaching of the other component upon exposure to increased pH or a two-component hydrogel with irreversible covalent cross-linking. For the PVA/PAA system, despite the fact that it is a weak hydrogen bonding pair, the pH stability can be enhanced significantly with a short heat treatment step. Therefore by changing the duration and temperature of heat treatment, the extent of esterification (cross-linking) could be controlled, resulting in tunable pH-disintegration behavior. Furthermore, with sufficient heat treatment it is possible to fabricate a reversibly pH-responsive thin hydrogel which provides a stable platform for further functionalization.

Biocompatibility is related to the behavior of biomaterials. Biocompatibility can be defined several ways. First, biocompatibility can be the ability of a material to perform with an appropriate host response in a specific application. Second, biocompatibility can be the quality of not having toxic or injurious effects on the particular biological systems with which the material is interacting. Third, a measure of biocompatibility can be the comparison of the tissue response produced through the close association of the implanted candidate material to its implant site within the host animal to that tissue response recognized and established as suitable with control materials. Fourth, biocompatibility can refer to the ability of a biomaterial to perform its desired function with respect to a medical therapy, without eliciting any undesirable local or systemic effects in the recipient or beneficiary of that therapy, but generating the most appropriate beneficial cellular or tissue response in that specific situation, and optimizing the clinically relevant performance of that therapy. Finally, biocompatibility can be the capability of a prosthesis implanted in the body to exist in harmony with tissue without causing deleterious changes.

The term may refer to specific properties of a material without specifying where or how the material is used or to more empirical clinical success of a whole device in which the material or materials feature. Biocompatibility testing can include a large battery of in vitro tests used in accordance with particular standards. These tests do not necessarily determine the biocompatibility of a material, but can constitute an important step towards the animal testing and finally clinical trials that will determine the biocompatibility of the material in a given application, and thus medical devices such as implants or drug delivery devices.

PVA is a water soluble, synthetic, biocompatible polymer. It has a large number of hydroxyl groups that can react with many kinds of functional groups. In terms of its biocompatibility, it is widely being used in sensors and in drug delivery systems. In addition to being biocompatible, PVA is biodegradable, thermally stable, resistant to organic solvents and oils, does not present electrical charges, and is non-toxic and non-carcinogenic. PVA also shows a good adhesion to organic and inorganic materials, and it can form films with high mechanical strength and durability. PVA is used to produce capsules for drugs and fibers for surgical interventions. In aqueous solutions the PVA can become biodegradable.

Functional compounds, such as fluorescent compounds, biomolecules, or other compounds imparting a desired function or property, can be attached to the films. Biomolecules can include proteins (including, e.g., antibodies and other proteins capable of specific binding to a binding partner), carbohydrates, lipids, nucleic acids, and metabolites. For example, a biomolecule can be covalently attached to reactive functional groups present in the coating, e.g., carboxylic acid groups or hydroxyl groups. Because different reactive functional groups in the coating can have different reactivity, multiple different functional compounds can be simultaneously attached to a coating.

For example, when the coating includes both carboxylic acid groups and hydroxyl groups, a first functional compound having an amine group can be covalently attached to carboxylic acid groups by carbodiimide chemistry, which avoids attachment to the hydroxyl groups. A second, different functional compound having hydroxyl groups can be covalently attached to hydroxyl groups of the coating by dialdehyde chemistry. In this way, coatings having more than one functional compound (e.g., biomolecule) attached can be prepared.

### EXAMPLES

Materials and Chemicals: Carboxymethylcellulose (CMC) (Mw=250,000), chitosan (CHI) (Low Molecular Weight), alginic acid sodium salt (viscosity 20,000-40,000 cps) and sodium chloride were obtained from Sigma Aldrich. Poly(acrylic acid) (PAA) (25% aqueous solution, Mw=90,000) was obtained from Polysciences (Warrington, Pa.). Deionized water was exclusively used in all aqueous solutions and rinsing procedure. Glass slides were microscopy slides obtained from VWR (VWR microslides premium plain Cat. No. 48300-047) 3×1 inch and 1 mm thick. Polycarbonate slides were obtained from Teijin Chemical Ltd. 1-ethyl-3-(3-dimethylaminopropyl)carbodiimide hydrochloride (EDC) and N-hydroxysulfosuccinimide (NHS) were purchased from Thermo Scientific. Poly(acrylic acid)-graft-poly(ethylene oxide) (PAA-g-PEO) was synthesized according to the procedures of Irvine et al., Biomacromolecules 2, 85 (2001); and Mayes et al., J. Mem. Sci. 298, 136 (2007), each of which is incorporated by reference in its entirety.

Thickness measurements for multilayers assembled on glass substrates were performed with a Tensor P16 surface profilometer (PL) using a 2 μm stylus tip and 2 mg stylus force. The topographical image of the multilayer was collected using a Nanscope IIIa, Dimension 3000 AFM microscope (Digital Instruments, Santa Barbara) in the tapping mode in air. Variable-angle spectroscopic ellipsometry (EL) was used to measure the thickness and refractive index of the coating on polycarbonate substrates. Contact angle measurements were carried out with a VCA-2000 contact angle system (AST Products, Inc., MA). Contact angle values were calculated from dynamic video files that captured at 60 frames/s using the software provided (VCA Optima XE Version 1.90) by the manufacturer.

The anti-fog properties were evaluated by a slightly modified European Standard Test (EN168, which is incorporated by reference in its entirety) and by a humidity chamber and aspiration test. In the first case, the temperature of water in the humidity chamber and the humidity of the chamber were set at 23° C. and 100% respectively. The relative transmittance of a sample was evaluated as a criterion for the anti-fog properties of the coating. The relative transmittance was recorded as (Tr %)=(T_{f}/Tᵢ)*100, where the transmittance of the coating during the fogging condition is (T_{f}), and the initial transmittance in non-fogging conditions is (Tᵢ). In the second case, a climate chamber was used to set up different environmental conditions. The humidity within the chamber was controlled with an ultrasonic humidification system and ventilation system. A slide coated with an antifog coating was evaluated by recording an image of the slide at 37° C. and 80% humidity at various times in the chamber. For quick evaluation of the antifog performance of the coatings, a simple test was used involving simply aspirating/breathing on the samples.

Mechanical strength of coatings was evaluated by a pencil hardness tester, a Kimwipe test, and a cloth-sponge test. In the Kimwipe test, the coating on a substrate was rubbed by hand vigorously by using laboratory Kimwipes 10 times. In the pencil hardness test, the coating on the glass substrate was tested according to ASTM D3363 (also referred to as ECCA-T4/1 or ISO 15184), each of which is incorporated by reference in its entirety. The coated substrate was placed horizontally under the pencil tip and the pencil tester was moved in one direction. The force applied to the pencil tip came from a 750 g load. The scratched regions were evaluated by optical microscopy. In the cloth-sponge test, the coating was first wet with water or soap solution (2% MICRO-90 solution from International Products Corporation) and rubbed with a cloth (ANTICON, Lot#5562) or a cellulose sponge under different conditions. In the first test, the wet coating was rubbed with a wet sponge ten times. In the second test, the wet coating was rubbed with a wet cloth ten times. In the third test, the wet coating was rubbed with a dry cloth ten times. The last challenge was considered the most rigorous test of mechanical strength among the cloth-sponge tests.

Hydrophilic antifog coatings were prepared on glass, polycarbonate, and sapphire substrates by using a simple layer-by-layer dipping or spraying technique. This process, called “layer-by-layer” assembly involves the sequential contacting of the substrate into solutions of different polymers. When two different polymer solutions are used, the deposition of each cycle of complimentary polymers creates a “bilayer,” which includes a molecular-level blend of the polymers. The notation (Poly1/Poly2)ₙ conveniently describes the structures of assembled coatings. Here, Poly1 and Poly 2 are the abbreviations that identify specific polymers used in assembly and n is the number of bilayers deposited. Therefore, a ten bilayer coating comprising chitosan and carboxylmethylcellulose can be noted as (CHI/CMC)₁₀.

The assembled coatings can be rendered more mechanically robust by covalent crosslinking. Crosslinking can be achieved, for example, by using well-established EDC/NHS chemistry, or by thermal treatments (for example, in the range of 100° C. to 250° C., e.g., at 130° C.). The coatings prepared from either chitosan/carboxymethylcellulose or chitosan/poly(acrylic acid-polyethylene oxide copolymer) exhibited hydrophilic wetting properties. The polar groups or elements of these polymers can have strong interactions with water via polar-dipole, H-bonding, or polar-polar interactions. As a result, the growth of light-scattering water droplets can be inhibited, because water condensing on the coated surface interacts more strongly with the polymer(s) than with other water molecules. Natural polymers such as chitosan, or carboxylmethylcellulose and synthetic copolymers such as poly(ethylene oxide) grafted poly(acrylic acid) copolymers, are particularly well suited for this effect and significantly outperformed commonly used polyelectrolytes (PE) such as poly(acrylic acid) (PAA), and poly(allyamine) (PAH). The ability of CHI, CMC, and PAA-co-PEG to inhibit droplet growth can be related to their ability to interact strongly with water via hydrogen bonds. For example, in antifog experiments, the multilayer systems prepared from PAA and CHI or from PAH and CMC did not provide acceptable antifog performance. Also, chemically immobilized monolayers of these materials on glass substrates did not provide acceptable antifog properties. All of these coatings (i.e., natural polymer/simple synthetic polyelectrotye, such as CHI/PAA and CMC/PAA) failed both the humidity chamber and aspiration tests.

To investigate the effect of degree of hydrolysis and molecular weight on the interpolymer complexation behavior and thus on growth behavior and stability of films, a number of different PVA samples were obtained from Sigma-Aldrich (P1: M_{w}=24 500 g/mol, PDI=1.99, 87-89% hydrolyzed, P2: M_{w}=88 400 g/mol, PDI=1.18, 87-89% hydrolyzed, P3: M_{w}=131 000 g/mol, PDI=1.50, 87-89% hydrolyzed, F1: M_{w}=21 400 g/mol, PDI=1.22, 98-99% hydrolyzed, F2: M_{w}=144 000 g/mol, PDI=1.34, 98-99% hydrolyzed). Each sample was dissolved in a pH 7.0 buffer solution (0.2 M sodium nitrate, 0.01 M sodium phosphate) at a concentration of 2 mg/mL and characterized using gel permeation chromatography (GPC) (Agilent Technology 1260 Infinity, Wyatt Optilab T-rEX detector, PL Aquagel-OH column). The resulting molecular weight and polydispersity values are summarized in Table 3.

2-Butanone (MEK, 99+% A.C.S. reagent) and methylene blue dye were obtained from Sigma-Aldrich. Poly(acrylic acid) (PAA, M_{w}=225 000 g/mol, 20% aqueous solution), poly(methacrylic acid) (PMAA, M_{w}=100 000 g/mol), and poly(glycidyl methacrylate) (PGMA, M_{w}=25 000 g/mol, 10% solution in MEK) were obtained from Polysciences. Standard (soda lime) glass microscope slides were obtained from VWR. Deionized water (DI, 18.2 MΩ·cm, MilliQ) was used in all aqueous polymer solutions and rinsing procedures.

TABLE 3
The number average molecular weight (Mₙ), weight average
molecular weight (M_{w}) and the polydispersity index (PDI =
M_{w}/Mₙ) of the PVA samples^{a} used in this work.

| PVA Samples | Mₙ (10⁴ g/mol) | M_{w} (10⁴ g/mol) | PDI (M_{w}/Mₙ) |
|---|---|---|---|
| P1 | 1.23 | 2.44 | 1.99 |
| P2 | 7.50 | 8.84 | 1.18 |
| P3 | 8.73 | 13.1 | 1.50 |
| F1 | 1.76 | 2.14 | 1.22 |
| F2 | 10.8 | 14.4 | 1.34 |

^{a}P: partially hydrolyzed PVA, F: fully hydrolyzed PVA, dn/dc was measured with five different concentrations (0.1, 1, 3, 4, 5 mg/mL) of P3, F2 in pH 7.0 buffer solution (0.2M sodium nitrate, 0.01M sodium phosphate). The calculated values of dn/dc for partially hydrolyzed and fully hydrolyzed PVA were 0.147 mL/g, 0.153 mL/g respectively.

### Example 1

### Coating Assembly

The adsorption of all polymer/polymer systems on glass, sapphire, and polycarbonate slides was carried out with a Stratosequence VI spin dipper (Nanostrata inc.) controlled by StratoSmart v6.2 software. Dipping times for the polymers were 10 minutes followed by three rinses in the same pH water as the pH of polymer solution. One two-minute and two one-minute rinses were used between polymer dips. The concentration of chitosan (CHI) and carboxymethylcellulose (CMC) was 0.1 wt %. In the CHI/PAA-g-PEO coatings, the concentration of PAA-g-PEO was 0.07 wt %. The pH of the polymer solutions and water was adjusted with either HCl or NaOH.

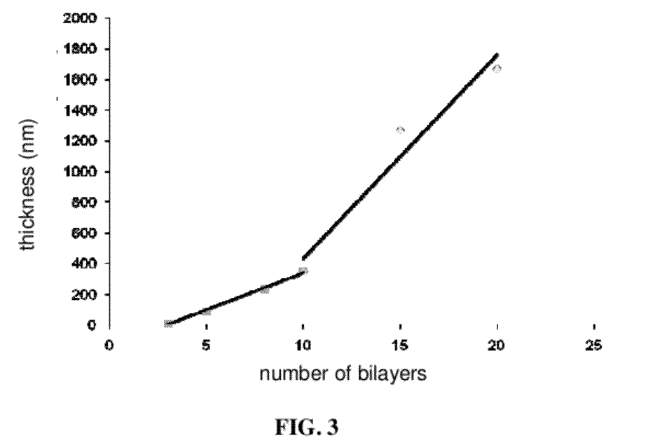

The thickness growth of the chitosan/carboxymethyl cellulose system as a function of the number of deposited bilayers on glass substrates was measured (FIG. 2). The thickness of a 10 bilayer coating was around 23 nm. When the number of bilayers was 20, the thickness of the coating reached 72 nm. The thickness of a 30-bilayer coating rose to 570 nm on a glass substrate. The same growth trend was found on polycarbonate substrates. The thickness growth of chitosan/PAA-g-PEO coatings was also measured (FIG. 3). Thicknesses of 8 and 10 bilayer coatings were 200 nm and 300 nm, respectively.

### Example 2

### Crosslinking Chemistry

the chitosan and carboxymethylcellulose system was crosslinked by using traditional coupling reactions involving EDC and NHS. A 10 bilayer (CHI/CMC)₁₀ coating assembled at pH 4 onto glass and polycarbonate substrates was immersed into a pH 4.5 solution of 400 mM EDC and 100 mM NHS for 15 minutes and then rinsed with the same pH.

### Example 3

### Anti-Fog Tests

The transmission of coatings on glass and polycarbonate was measured at 100% humidity and 23° C. The crosslinked 10 bilayer CHI/CMC coating showed high transparency (94%). After the substrate was placed into the humidity chamber for 120 seconds, the relative transmission (Tr) was 95%. The relative transmission (Tr) of the coating on polycarbonate after this treatment was 75%.

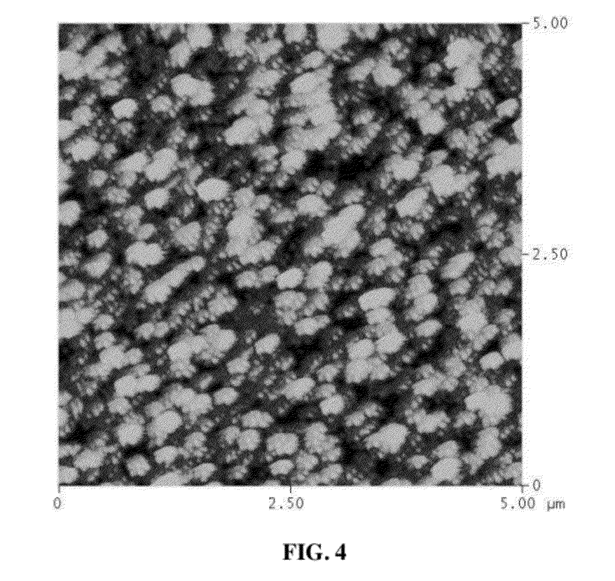

The transmission of the chitosan/PAA-g-PEG coating on glass and polycarbonate was measured at 100% humidity and 23° C. Coatings having 15 bilayers showed high transparency on glass (92%). After the substrate was placed into the humidity chamber for 70 seconds, the relative transmission (Tr) was 100%. The relative transmission (Tr) of the coating on polycarbonate was 99%. The haze of the both coatings was 0.2%, which was much better than the 5% haze of a coating as described in U.S. Pat. No. 5,804,612, which is incorporated by reference in its entirety. FIG. 4 shows a topographical image of a crosslinked 10 bilayer chitosan/carboxymethyl cellulose coating prepared on a glass substrate.

Both coatings showed excellent anti-fog performance by the aspiration and humid chamber test. The second humid chamber test was conducted at 80% humidity and 37° C. and images were recorded after 1 sec, 10 sec, 30 sec, 2 minutes, 3 days, and one week. Both coatings show excellent anti-fogging performance—no fogging was observed from 1 second to one week.

### Example 4

### Aging Studies

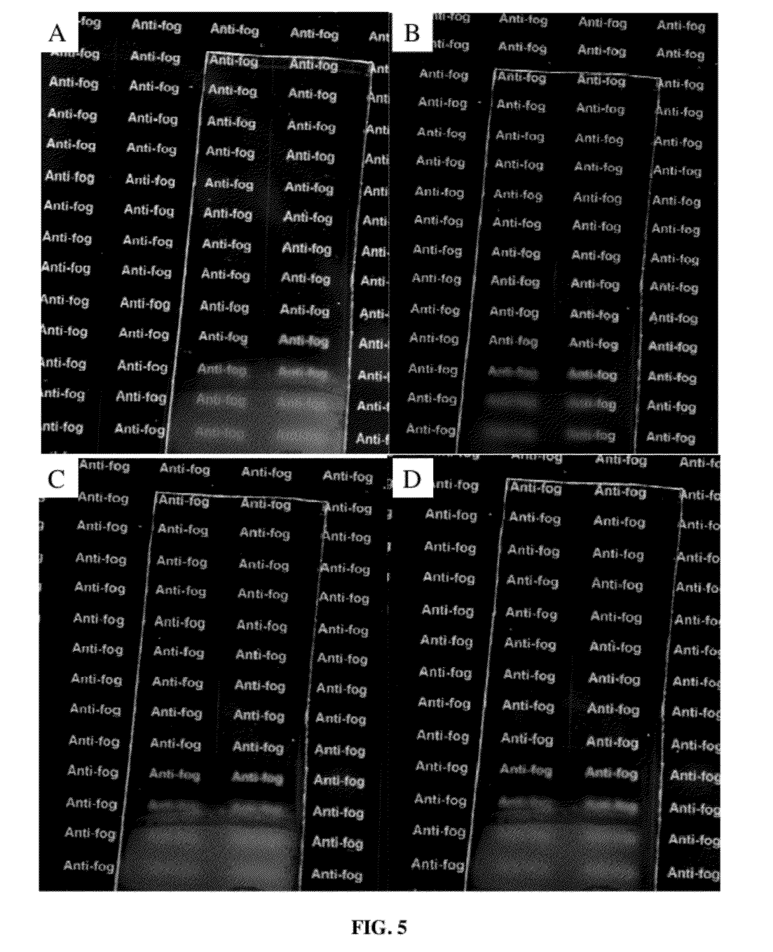

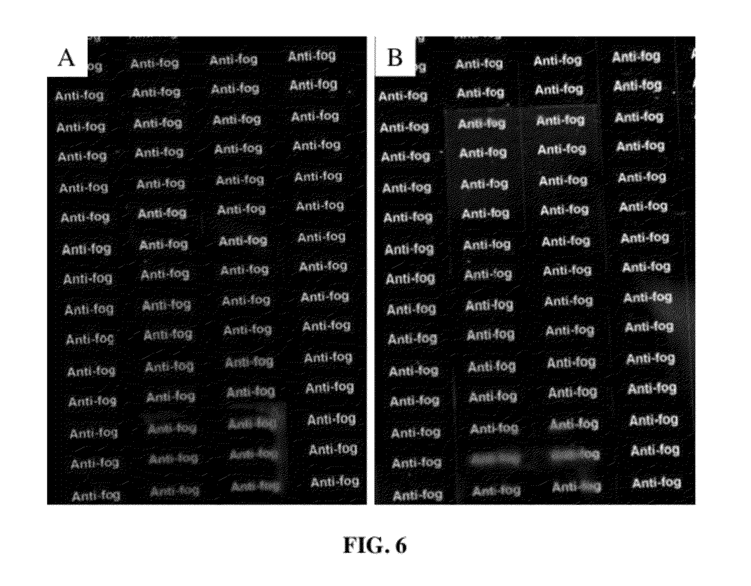

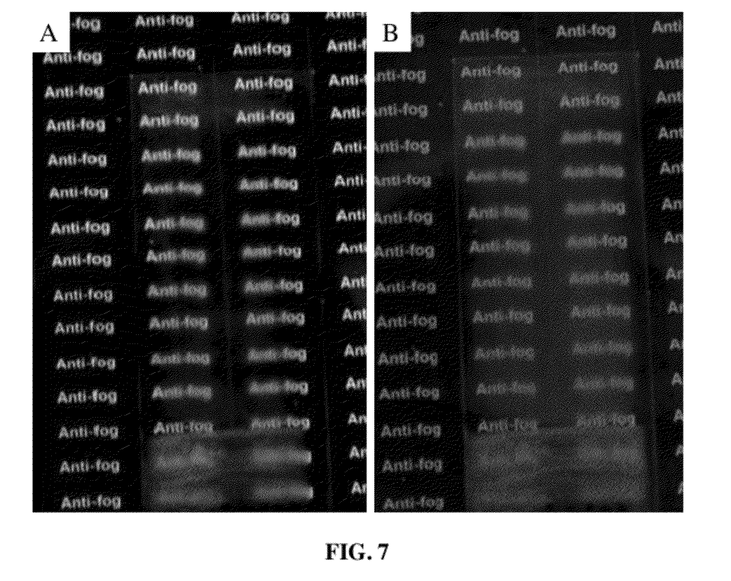

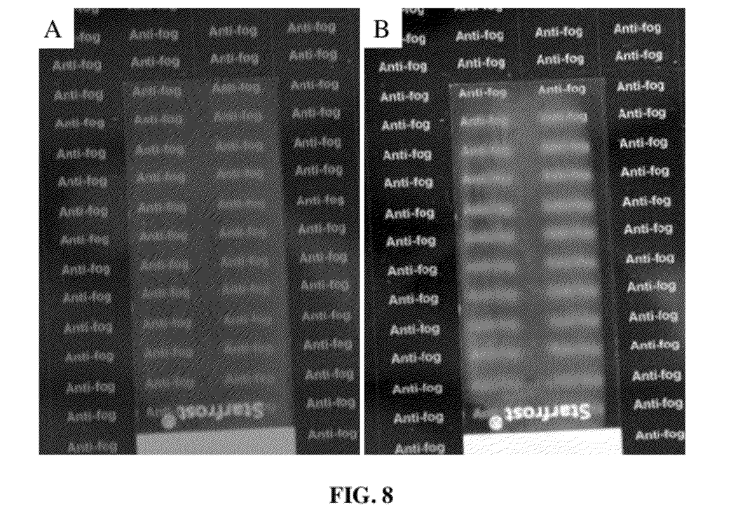

Both types of antifog coatings showed excellent and long lasting anti-fog performance after being placed in a refrigerator (0° C. to 4° C.) for one month. Images of the coatings recorded after this treatment are shown in FIG. 5. Both coatings were tested after storage in air for two months. They still showed excellent antifog properties.

### Example 5

### Different Copolymer Compositions

To find out the hydrophilicity effect on the coating of chitosan and PAA-g-PEG, PAA-g-PEG copolymers with different ratios of poly(acrylic acid) and poly(ethylene oxide) were synthesized and their antifog properties were evaluated. When the PEG component in the PAA-g-PEG copolymer was 37% by weight (FIG. 6), the chitosan and PAA-g-PEG coating displayed excellent antifog performance. When the PEG amount in the copolymer was 25% by weight, the chitosan and PAA-g-PEG coating did not exhibit good antifog performance (FIG. 7). The images in FIGS. 6-7 were recorded with the samples in the humidity chamber at 37° C. and 80% humidity at the time interval of 1 second and 20 seconds.

### Example 6

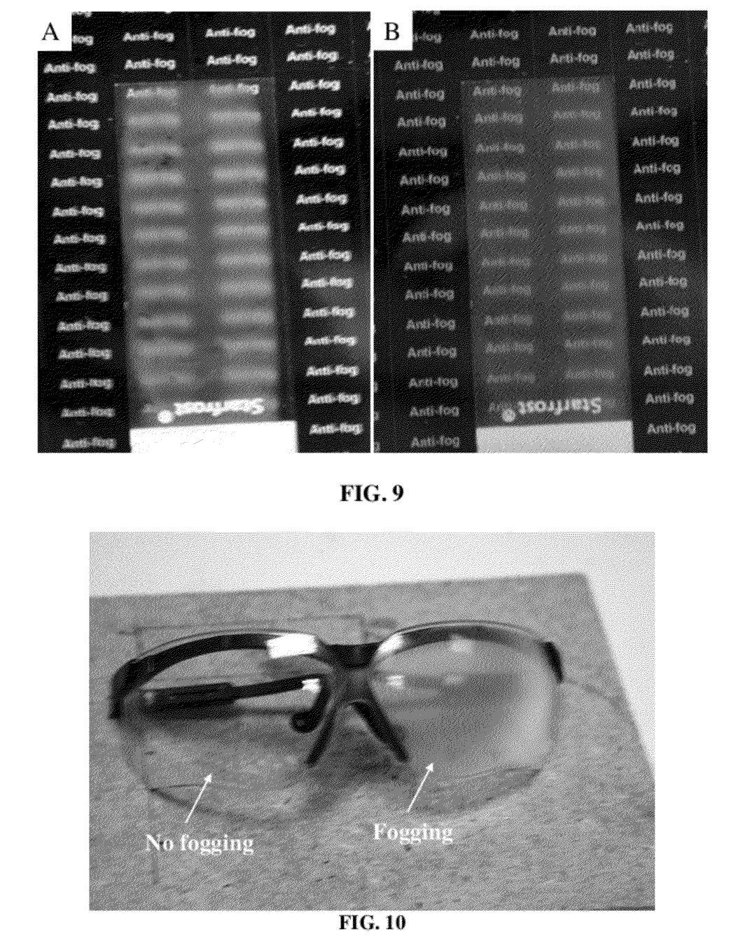

Excellent antifog properties required a critical thickness of the molecularly blended hydrophilic polymers. For the chitosan/CMC multilayer, the coating had good antifog properties when the thickness was greater than 20 nm. For the chitosan/PAA-g-PEG multilayers, good antifog performance was achieved when the coating was at least 10 nm thick. A single layer coating comprised of only carboxy methylcellulose or PAA-g-PEG chemically bonded to a surface did not exhibit anti-fog performance. Such coatings fog immediately when placed in the humidity chamber (37° C. and 80% humidity) (FIGS. 8-9). This demonstrated that molecularly blended layers of suitable hydrophilic polymers are needed to create a long-lasting anti-fog coating.

### Example 7

### Coating for Safety Goggles

One lens of a polycarbonate safety goggle was coated with 10 bilayers of chitosan and PAA-g-PEG; the other lens was left uncoated. The goggles were then placed in a refrigerator for one month at 4° C. The coated goggle was removed from the refrigerator and an image was taken after exposure to hot water steam. The coated lens exhibited excellent antifog performance whereas the non-coated lens fogged immediately in steam (see FIG. 10).

### Example 8

### Anti-Fog Tests for Glass Substrates

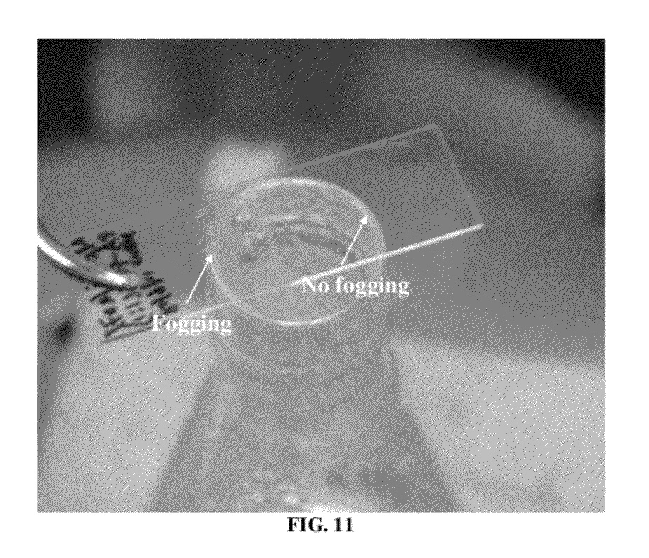

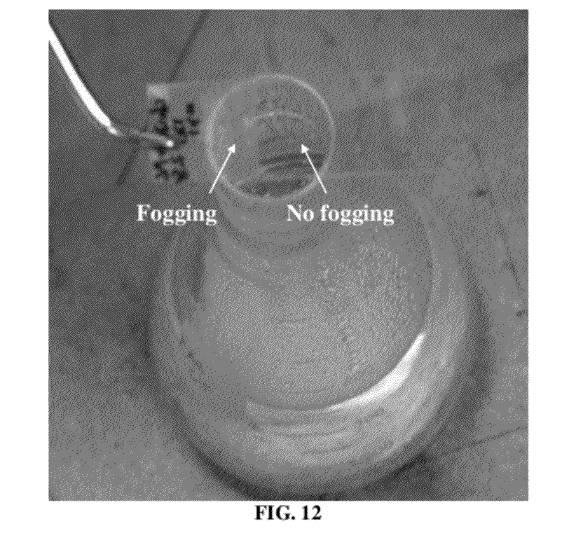

two glass substrates coated with different coatings were evaluated by direct exposure to hot steam after being placed in the refrigerator for two weeks. As shown in FIGS. 11-12, the coatings comprising either chitosan and PAA-g-PEG (37% PEG) or chitosan and PAA-g-PEG (50% PEG) showed excellent anti-fog properties.

### Example 9

### Mechanical Durability Test

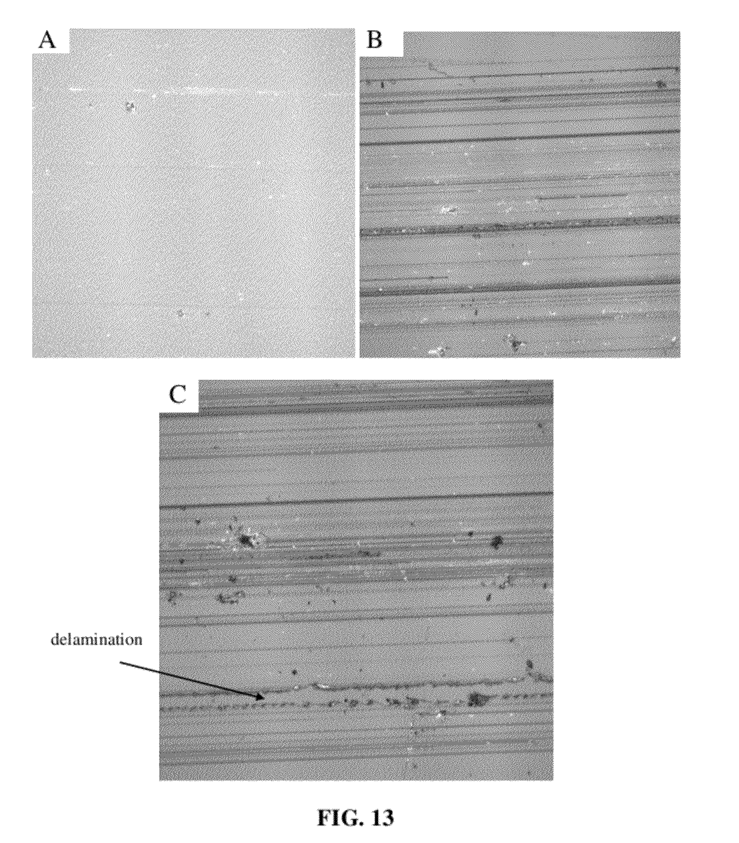

The mechanical durability of the CHI/CMC and CHI/PAA-g-PEG (37% PEG) coatings was examined by aggressive wiping with a laboratory Kimwipe. After wiping, no visible damage was observed in either coating; and both coatings retained their antifog properties. This observation contrasted to antifog coatings based on nanoporous arrays of nanoparticles (see, for example, U.S. Patent Application Publication No. 2008/0268229, which is incorporated by reference in its entirety). Aggressive wiping compromised the antifog behavior of nanoparticle-based coatings, due to a smoothing of the surface layers. The excellent mechanical strength of both polymer-based coatings was further enhanced upon chemically bonding to a glass substrate. A pencil hardness test of CHI/CMC and CHI/PAA-g-PEO as-assembled coatings revealed a hardness of 2H. Thermally crosslinked coatings had a pencil hardness of 6H, and no delamination was observed by optical microscopy. FIGS. 13A-13C shows the pencil hardness of 15 bilayers of chitosan and PAA-g-PEG (37% PEG) at different pencil tests. Its hardness shows 2H. A 7H pencil applied to the coating caused delamination of the coating (FIG. 13 C).

### Example 10

### Enhancing the Mechanical Strength of the Anti-Fog Coating

Glass and other silica-rich substrates, certain polymeric substrates, and sapphire substrates can be chemically modified before a coating is applied; the modification can enhance the mechanical strength of the coating. Silica-rich substrates include transparent substrates that have reactive silanol groups, such as, for example, glass, silica, and quartz. Polymeric substrates that can be chemically modified before a coating is applied include polycarbonate and PMMA. Substrates were chemically modified by forming covalent bonds between an epoxysilane compound (3-glycidoxypropyl)trimethoxysilane and the hydroxyl or silanol groups on the substrates. This modification proceeded via hydrolysis and condensation reactions. Branched poly(ethyleneimine) (PEI) was then exposed to the epoxy-functionalized surface. Reactive amino groups of PEI react with epoxy groups, providing a modified surface having amino groups.

The glass-like substrate was first sonicated in water for 5 minutes and cleaned in an oxygen plasma for 2 minutes at 120 mTorr or heated in piranha solution for 30 minutes at 80° C. The cleaned substrate was immediately incubated with a anhydrous toluene solution of 1% (3-glycidoxypropyl)trimethoxysilane overnight, then rinsed with pure toluene. Toluene can be replaced by other anhydrous organic solvents such as chloroform and hexane. The dried substrate was immersed in a 0.01 M aqueous solution of branched PEI (pH=9) for at least 4 hours and subsequently rinsed with water. Next, multilayers of CHI/CMC were assembled onto the PEI-modified substrate. The substrate with the assembled multilayer of CHI/CMC was then immersed into 0.05 M MES buffer (pH 5) including 200 mM EDC and 50 mM NHS for 30 minutes and subsequently immersed into 1×PBS buffer for 20 minutes. The crosslinked multilayer of CHI/CMC on the glass-like substrate was then rinsed with water. The antifog coatings thus formed were not only chemically bonded between layers, but also chemically bonded to the functionalized substrates.

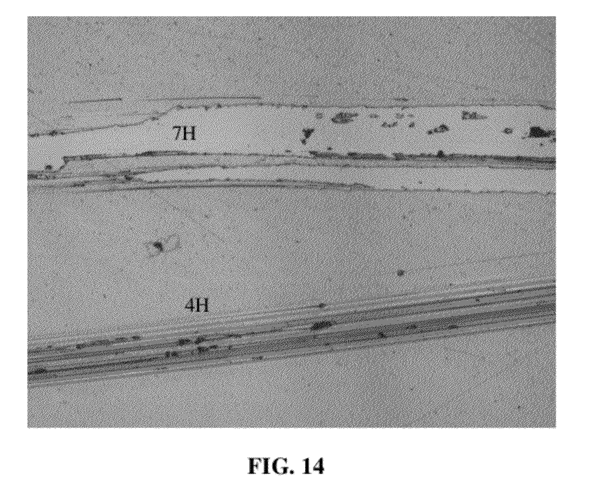

To further crosslink the multilayers, the coating was then immersed into an aqueous solution of 2.5% glutaraldehyde (pH=9) at 30° C. for 45 minutes. The substrate was then rinsed with water. The crosslinked coatings on a glasslike or sapphire substrate were evaluated by a KIMWIPE test, pencil test and cloth-sponge test. The KIMWIPE test showed no visible scratches and excellent mechanical strength. A pencil test of the EDC/NHS and glutaraldehyde crosslinked (CMC/CHI)_{15.5} coating showed a 4H pencil hardness (FIG. 14). At a pencil hardness of 7H, this coating exhibited delamination. A 12.5 bilayer coating of CMC/CHI crosslinked with EDC/NHS showed no damage after rubbing with a wet cloth or a wet sponge; however, scratches and/or delamination occurred after being rubbed in the wet condition with a dry cloth. In contrast, the 12.5 bilayer coating of CMC/CHI crosslinked with both EDC/NHS and glutaraldehyde showed no visible damage after the wet coating was rubbed with dry cloth.

### Example 11

### PGMA Anchoring Chemistry

The glass substrates were degreased by sonication in a 4% (v/v) solution of Micro-90 (International Products Co.) for 15 min, and subsequently sonicated twice in DI water for 15 min and dried with compressed air. They were then treated with oxygen plasma (PDC-32G, Harrick Scientific Products, Inc.) for 2 min at 150 mTorr. A plasma-treated glass slide was immediately immersed in a 0.1% (w/v) PGMA/MEK solution for 20 sec and then placed in a 110° C. oven for 30 min to covalently bond PGMA to the substrate. After cooling to ambient temperature, the PGMA-coated glass substrate was immersed in a 1 mg/mL aqueous solution of PVA (pH 2.0) for 20 min. The PVA-coated substrate was then dried at ambient temperature and again placed in the oven at 110° C. for 30 min to induce a chemical reaction between the residual epoxy groups present in PGMA and the PVA hydroxyl groups. Silicon wafers were treated with the same protocol.

### Example 12

### PVA Thin Film Assembly

Films were constructed using a Stratosequence VI spin dipper (Nanostrata Inc.) controlled using StratoSmart v6.2 software. Substrates were first rinsed three times using DI water of the same pH as the proceeding PVA solutions to remove loosely bound PVA from the substrate. LbL assembly was then commenced with dipping times of 10 min for the polymer solutions, followed by three rinses of 2, 1, and 1 min. The concentration of the polymer solutions used was 1 mg/mL and the pH of these solutions and the rinse water were adjusted with 0.1 M HCl or 0.1 M NaOH. The nomenclature for LbL films follows the convention (“polycation”/“polyanion”)_{Z} where in our case, polycation and polyanion can be replaced by hydrogen bonding acceptor and donor respectively. Also Z is the total number of bilayers deposited.

### Example 13

### Functional Modification with FITC-BSA/RB-PEG

Prior to the functionalization study, (PVA_{P3}/PAA)₃₀ film was heated for 5 min at 140° C. to pH stabilize in the cross-linking solution. Then the film was immersed in 0.1 M EDC and 0.1 M NHS solution in 50 mM MES buffer (pH 5.0) for 30 min. The sample was rinsed with 50 mM MES buffer (pH 5.0) for 10 sec and immediately immersed in 1 mg/mL FITC-BSA in MES buffer (pH 6.0) for 2 hrs. After rinsing with DI water, the sample was soaked in 0.1% (v/v) Tween-20 in PBS (pH 6.0) for either 3 hrs or 15 hrs on the shaker plate set at 100 rpm. Samples were rinsed thoroughly with DI water and dried with compressed air. Control samples were prepared with the same protocol without the EDC/NHS. After FITC-BSA was attached to the film, the sample was immersed in 0.5 mg/mL RB-PEG solution for 30 min. Then the sample was soaked in 30° C. 0.13% (w/w) glutaraldehyde in PBS for 10 min, rinsed with DI water and dried with compressed air. Similarly, control sample was prepared without the glutaraldehyde cross-linking.

### Example 14

### PVA Thin Film Characterization

Dry film thicknesses were measured using a Tencor P16 surface profilometer with a 2 μm stylus tip, 2 mg stylus force, and a scanning rate of 50 μm/s. To determine wet film thicknesses in situ, a custom-built quartz cell was used in conjunction with a J.A. Woollam XLS-100 spectroscopic ellipsometer as described previously. See, for example, Kharlampieva, E.; Sukhishvili, S. A. 2006, 46, 377-395, which is incorporated by reference in its entirety. Data were collected between 400 and 1000 nm at a 70° incidence angle and analyzed with WVASE32 software. To measure the extent of reversible swelling, the thickness of each film was measured first when immersed in water of a designated pH 10 min and then after drying with compressed air. Topographical images of the multilayers were obtained using a Veeco Nanoscope V Dimension 3100 AFM microscope in tapping mode. The extent of polymer complexation was determined by measuring the attenuation of light due to scattering using UV-VIS spectroscopy (Varian Cary 50 Bio) over the 370-750 nm range 10 min after the mixing of two hydrogen bonding polymer solutions. IR spectra of films deposited on ZnSe plates were taken using a Nicolet 4700 FT-IR Spectrometer (Thermo Scientific). The extent of pH-triggered disintegration was determined by measuring the ratio of the dry film thickness before and after 2 hr incubation in pH-adjusted DI water. NMR spectra of samples dissolved in deuterated water were obtained on a Varian Mercury-300 spectrometer. The presence of carboxylic acid groups was probed using methylene blue as described previously. See, for example, Yoo, D.; et al. Macromolecules 1998, 31, 4309-4318, which is incorporated by reference in its entirety.

### Example 15

### Interpolymer Complex of PVA in Aqueous Solution

Prior to incorporating PVA within multilayer films, interpolymer complex formation between a variety of PVA samples and complementary polymers PAA and PMAA were studied to determine which polymer pairs hydrogen bond to form water insoluble complexes and under what conditions. This simple test is known to be a prerequisite for successful construction of hydrogen bonded LbL films. See, for example, Kharlampieva, E.; et al. Adv. Mater. 2009, 21, 3053-3065, which is incorporated by reference in its entirety. Polycarboxylic acids and proton-accepting polymers can form interpolymer complexes through hydrogen bonding interactions. See, for example, Bailey, F. E.; et al. Journal of Polymer Science Part a-General Papers 1964, 2, 845, which is incorporated by reference in its entirety. Mixing PAA and proton-accepting polymers such as PEO in aqueous solution results in cooperative hydrogen bonding interactions which induce mutual screening of the hydrophilic functional groups and consequently strong insolubilization of the resultant complexes. See, for example, Chen, Y.; et al. Langmuir 2010, 26, 9011-9016, which is incorporated by reference in its entirety. As a result, polymer complexes coil up into a compact structure and water-insoluble aggregates are formed.

Incorporation of PVA into a multilayer film has a number of advantages such as ease of modification, high wettability and the capability to react with polycarboxylic acids to form ester linkages. One interesting property of PVA is that although its monomer unit is isomeric with that of PEO, its hydrogen bonding properties are very different due to the presence of hydroxyl groups. Not only can it form hydrogen bonds with another chain (inter-chain hydrogen bonding) but also with hydroxyl groups on the same chain (intra-chain hydrogen bonding). PVA is made by hydrolysis of poly(vinyl acetate). Due to the fact that full hydrolysis requires harsh conditions and long reaction times, an appreciable fraction of the functional groups are residual acetate groups. Clearly, since the degree of hydrolysis determines the density of hydroxyl groups along the chain, it will also affect the behavior of PVA in solution. In aqueous PVA solutions, inter-chain and intra-chain hydrogen bonding as well as hydrogen bonding between PVA chains and water molecules are all important. See, for example, Briscoe, B.; Luckham, P.; Zhu, S. Polymer 2000, 41, 3851-3860, which is incorporated by reference in its entirety. The extent of these interactions is mainly determined by the degree of hydrolysis of the PVA chains.

Various PVA samples with different degrees of hydrolysis and different molecular weights were mixed with complimentary hydrogen bond donors to test for interpolymer complex formation. In addition to the degree of hydrolysis, molecular weight was also chosen as a variable because long molecular chains of PVA have impeded segmental motion which makes it more difficult for these molecules to crystallize and is thought to affect complexation with the complementary hydrogen bonding pair. See, for example, Budhlall, B. M.; et al. Macromolecules 2003, 36, 9477-9484, which is incorporated by reference in its entirety.

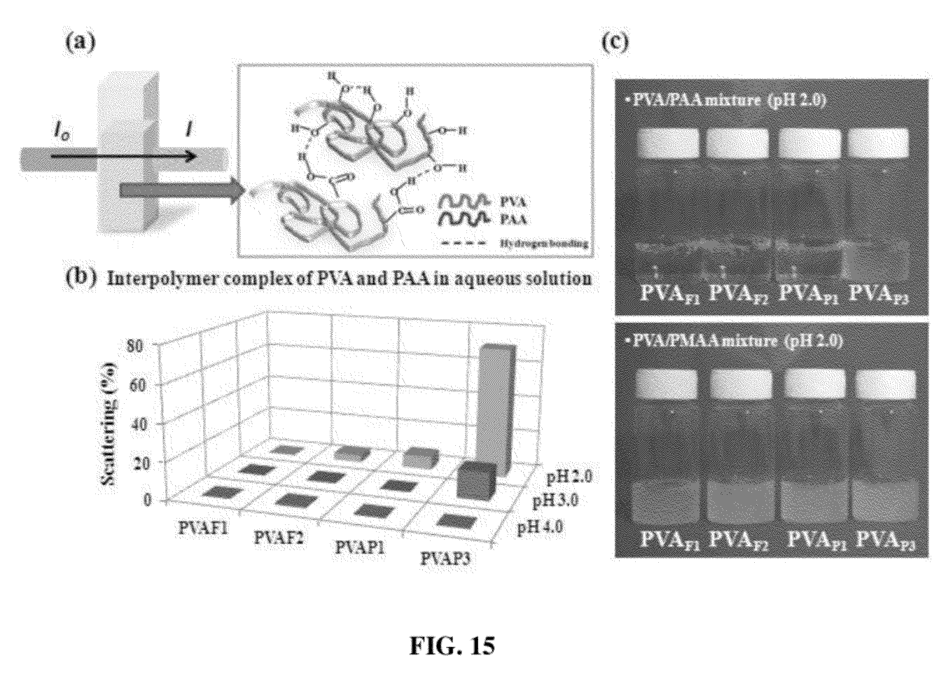

FIG. 15 displays the attenuation of transmitted light (I) (or transmission loss) induced by interpolymer complexes of PVA and PAA at different conditions. When using PAA as the proton-donating polymer, complexation strongly depends on the pH of the aqueous solution. While precipitation occurs at low pH, as the pH increases hydrogen bonding diminishes due to increased ionization of the PAA chains and consequently the attenuation of transmitted light decreases. The results show that even in pH 2.0 DI water where PAA is known to be fully protonated, complexes are not formed readily for both low and high molecular weight fully hydrolyzed PVA (F1, F2). However for partially hydrolyzed PVA (P1, P2, and P3) and especially for PVA_{P3}, there is a noticeable change in solution turbidity upon mixing the polymer solutions. For PVA_{P3}/PAA, the solution turbidity is also apparent even at pH 3.0, where PAA starts to ionize. This result in which partially hydrolyzed PVA with less hydroxyl functional groups undergoes more extensive complexation than fully hydrolyzed PVA is assumed to be due to the discrepancy between the real and ‘apparent’ number of hydroxyl groups accessible for carboxylic acid groups to hydrogen bond with. It has been reported that an increase in the number of hydrophobic acetate groups disrupts inter- and intra-chain hydrogen bonding, resulting in more ‘apparent’ hydroxyl groups and consequently increasing the solubility of PVA. See, for example. Budhlall, B. M.; et al. Macromolecules 2003, 36, 9477-9484, which is incorporated by reference in its entirety. It was also found that an aqueous solution of 98% hydrolyzed PVA showed a higher apparent viscosity than a solution of 87% hydrolyzed PVA, even though the molecular weight of the former solution was lower than that of the second. See, for example, Briscoe, B.; Luckham, P.; Zhu, S. Polymer 2000, 41, 3851-3860, which is incorporated by reference in its entirety. The data in FIG. 15C agree with this trend. To further explore this observation, PMAA was used to qualitatively evaluate how significant the effect of the degree of hydrolysis on interpolymer complexation is compared to the effect of the hydrogen bond donor. Previously it has been reported that PEO/PMAA complexes are more stable and stronger than PEO/PAA complexes due to the α-methyl group of PMAA. See, for example, Jeon, S. H.; Ree, T. Journal of Polymer Science Part A: Polymer Chemistry 1988, 26, 1419-1428, which is incorporated by reference in its entirety. Similarly it has been hypothesized that PVA would ‘interact’ more strongly with PMAA than PAA. The term ‘interact’ was chosen because information on individual hydrogen bonding strengths among hydrogen bonding donors is either not available or insufficient. Polycarboxylic acids such as PAA and PMAA are both broadly classified as weak hydrogen bonding donors in the hydrogen bonded LbL field. See, for example, Kharlampieva, E.; Sukhishvili, S. A. 2006, 46, 377-395, which is incorporated by reference in its entirety. Although calorimetric measurements of these hydrogen bonded complexes allow one to elucidate the effect of the α-methyl group of PMAA on hydrophobic interactions, decoupling the hydrogen bonding contribution is much more difficult due to fact that the conformations of individual polymers need to be considered. See, for example, suchida, E.; Abe, K. In Interactions Between Macromolecules in Solution and Intermacromolecular Complexes; Tsuchida, E., Abe, K., Eds.; Springer Berlin/Heidelberg: 1982; Vol. 45, p 1-119, which is incorporated by reference in its entirety. At pH 2.0, the conformations of PAA and PMAA are completely different since PMAA is more compact and rigid. See, for example, Ruiz-Perez, L.; et al. Macromolecules 2008, 41, 2203-2211, which is incorporated by reference in its entirety. From here on we will use the term “more strongly interacting” rather than “stronger hydrogen bond donor” to eliminate confusion. As shown in FIG. 15C, all solutions became turbid upon mixing with PMAA. From this, it is concluded that the effect of the extent of hydrolysis becomes significant only for weakly interacting pairs such as PVA and PAA. The concentration of each solution before mixing was 1 mg/mL and the pH was adjusted to 2.0 using HCl. All solutions were transparent before mixing and the attenuance was measured 10 min after mixing.

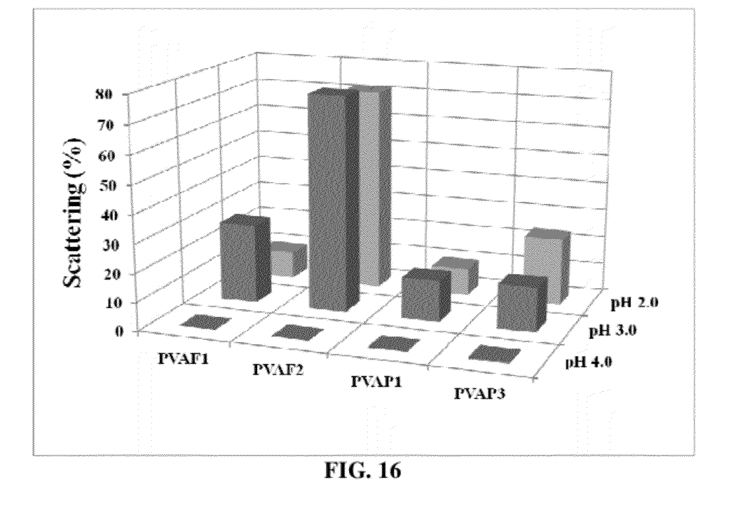

The analog of FIG. 15B for PVA/PMAA was also produced and is included in as FIG. 16. Although it is highly desirable to quantify the extent of complexation and to determine the cutoff point at which the driving force (mainly hydrogen bonding in our case) is insufficient for LbL assembly, the attenuance values reported above do not have direct physical meaning. Upon mixing, one could qualitatively predict whether a given polymer pair at a particular pH would assemble or not by simply observing the turbidity of the mixture. However, the method of quantification by measuring the attenuance after 10 minutes is limited in terms of determining whether LbL assembly will be successful or not because attenuation due to scatting is a transient phenomenon. This is evident in FIG. 16 where the more strongly complexing pair PMAA is of concern. The attenuation at pH 2.0 is highest for PVA_{F2}. Other PVA samples at the same conditions precipitated out within 10 minutes after mixing, resulting in lower attenuance than expected. Thus the interpolymer complexation test only offers a quick survey of whether or not a polymer pair has the potential to LbL assemble.

### Example 16

### Substrate Modification with PGMA Anchoring Chemistry

All multilayers were assembled from aqueous solutions of pH 2.0 with no added salt and were prepared on PGMA-modified glass substrates with the first layer of PVA covalently attached to the substrate as described above.

One major advantage of LbL assembly is that it can be used to create multilayer thin films on a variety of different substrates. However, especially for LbL assembly relying on weak driving forces such as hydrogen bonding, good adhesion to the substrate is a potential problem. This introduces major reproducibility concerns as reported previously with the analogous PEO/PAA system. See, for example, DeLongchamp, D. M.; Hammond, P. T. Langmuir 2004, 20, 5403-5411, which is incorporated by reference in its entirety. DeLongchamp and Hammond reported that even for carefully controlled assembly conditions, batch-to-batch variability was observed. Similar uncontrollable defects in these types of systems were also observed by Sukhishvili and Granick. See, for example, Sukhishvili, S. A.; Granick, S. Macromolecules 2001, 35, 301-310, which is incorporated by reference in its entirety. The PVA/PAA system behaved similarly in preliminary experiments in which the only pretreatment of the glass substrate was oxygen plasma. In particular, overall film quality was poor, exhibiting agglomerates and nonuniform thickness across the film. It is generally known that for systems where self-assembly or self-limiting adsorption/desorption is driven by weak interactions, multilayer buildup can consist of two stages: isolated islet growth and continuous film construction. See, for example, Picart, C.; et al. Proceedings of the National Academy of Sciences of the United States of America 2002, 99, 12531-12535, which is incorporated by reference in its entirety. Since the initial layers are not growing continuously but in domains, we hypothesized that this might contribute to the lack of reproducibility. A robust method to anchor various polymers to surfaces by attaching a macromolecular anchoring layer rich in epoxy functional groups to the substrate was recently introduced. See, for example, Iyer, K. S.; et al. Macromolecules 2003, 36, 6519-6526; Zdyrko, B.; et al. Polymer 2006, 47, 272-279; DeLongchamp, D. M.; Hammond, P. T. Langmuir 2004, 20, 5403-5411; and Sukhishvili, S. A.; Granick, S. Macromolecules 2001, 35, 301-310, each of which is incorporated by reference in its entirety.

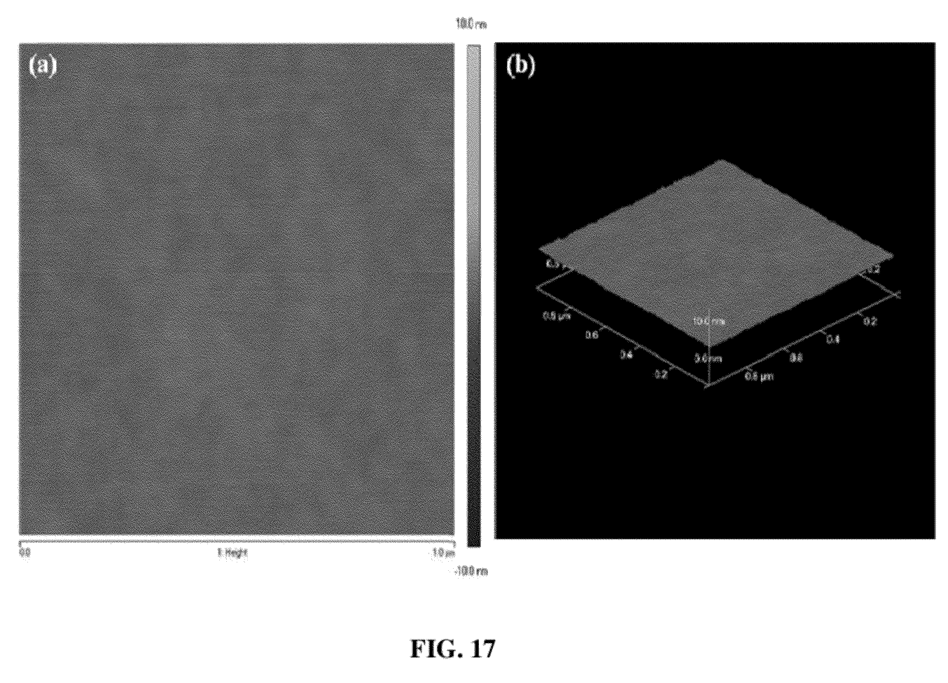

PGMA serves as a versatile anchoring interlayer to attach functional polymers, ensuring a strong bond between the grafted layer and the substrate. Using this method, the first layer of PVA was covalently bonded to the substrate. The film subsequently assembled on top of this layer showed dramatically enhanced thickness reproducibility and increased smoothness as shown in FIG. 17. Furthermore, anchoring of the PVA allowed for simplified characterization of the film. Strong adhesion to the substrate not only eliminated delamination of the film upon exposure to external stimuli but also simplified the swelling experiment and spectroscopy analysis. Others have used adhesion layers consisting of well-defined polyelectrolytes on substrates to minimize the substrate dependence and enhance film growth but this introduces another complexity by introducing more materials into the system. See, for example, Kim, J. Y.; et al. Chem. Mater. 2010, 22, 6409-6415. Due to these many advantages, all films were assembled on PGMA-anchored glass substrates.

### Example 17

### Layer-by-Layer Assembly of PVA with PAA

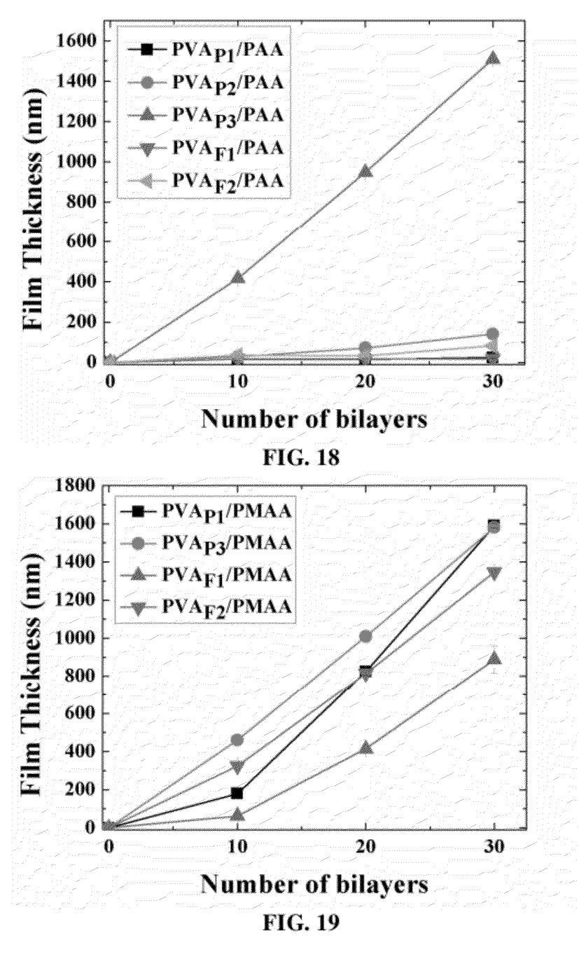

FIG. 18 shows the growth of PVA/PAA multilayers as LbL processing proceeds. Film growth was dramatically dependent on the molecular weight and degree of hydrolysis of PVA. Whereas the PVA_{Fx}/PAA systems exhibited very small thickness increments per deposition cycle even with high molecular weight PVA, growth of the PVA_{Px}/PAA systems was strongly dependent on the molecular weight of PVA. Table 4 shows the average thickness increment per bilayer for the PVA_{Px}/PAA systems.

TABLE 4
Average thickness increment per bilayer for (PVA_{P1}/PAA),
(PVA_{P2}/PAA), and (PVA_{P3}/PAA)^{a}.

| System | Thickness per bilayer (nm) |
|---|---|
| (PVA_{P1}/PAA) | 0.4 nm |
| (PVA_{P2}/PAA) | 5.7 nm |
| (PVA_{P3}/PAA) | 54.7 nm |

^{a}The thickness of the initial PGMA monolayer (3-5 nm) was taken into account when calculating the thickness per bilayer. The linear regime was considered to be from 10-30 bilayers.

For fully hydrolyzed PVA/PAA multilayers assembled at pH 2.0, small incremental thicknesses were observed and the film was generally rough. The largest bilayer thicknesses were observed for the PVA_{P3}/PAA system with an average value of 54.7 nm. This large value is comparable to the ˜80 nm per bilayer reported for PEO/PAA, which also features weak intermolecular hydrogen bonding with loopy conformations similar to those exhibited by weak polyelectrolytes. See, for example, Lutkenhaus, J. L.; et al. Journal of the American Chemical Society 2005, 127, 17228-17234 and Shiratori, S. S.; Rubner, M. F. Macromolecules 2000, 33, 4213-4219, each of which is incorporated by reference in its entirety. For the partially hydrolyzed PVA systems shown in Table 4, average bilayer thicknesses depend strongly on the molecular weight of the polymer used in the assembly. Interestingly, the measured roughness of the film was nearly as large as the film thickness itself for PVA_{P1}/PAA. Similar observations have been reported previously for the analogous PEO/PAA system, where a sevenfold increase in bilayer thickness was observed when the molecular weight of PEO was increased from 1.5 to 20 kDa. See, for example, DeLongchamp, D. M.; Hammond, P. T. Langmuir 2004, 20, 5403-5411, which is incorporated by reference in its entirety. However, as seen in FIG. 18 and Table 3, the increase in average bilayer thickness observed here are even more dramatic. This strong dependence of the bilayer thickness on molecular weight can likely be attributed to two factors. First, the intrinsically weak nature of hydrogen bonding interactions results in weak adsorption for low molecular weights, yielding very small thickness increments and significant roughness. On the other hand, long molecular weight chains of PVA have impeded segmental motion as explained above, making it more difficult for the molecules to fold up into crystalline structures and therefore leaving the hydroxyl groups more accessible for complexation. Furthermore, loopy conformations are more prevalent at increased molecular weights, resulting in higher average bilayer thicknesses. See, for example, Budhlall, B. M.; et al. Macromolecules 2003, 36, 9477-9484, which is incorporated by reference in its entirety.

### Example 18

### Layer-by-Layer Assembly of PVA with PMAA

For the PVA/PMAA multilayer system, growth occurred much more quickly than in the systems discussed so far. As predicted earlier by the complexation experiments, use of the more strongly interacting PMAA for hydrogen bonded assembly results in average thickness increments comparable to typical hydrogen bonded films, regardless of the molecular weight and the degree of hydrolysis. As shown in FIG. 19, all systems exhibited linear growth from 10 bilayers onward after a stable platform of PVA/PMAA was established.

### Example 19

### pH-Triggered Disintegration of Hydrogen-Bonded PVA/PAA or PVA/PMAA

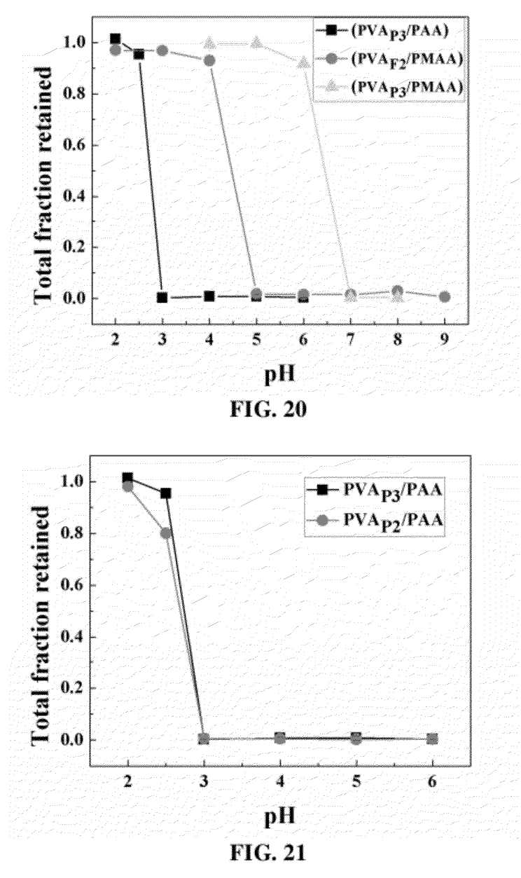

Polycarboxylic acids which have been incorporated into a hydrogen bonded multilayer assembly become ionized when exposed to high pH conditions, disrupting the overall multilayer structure. The critical pH at which film disintegration occurs was reported by others to be strongly dependent on the strength of the hydrogen bonding interactions within the film. See, for example, Sukhishvili, S. A.; Granick, S. Journal of the American Chemical Society 2000, 122, 9550-9551 and Kharlampieva, E.; Sukhishvili, S. A. 2006, 46, 377-395, each of which is incorporated by reference in its entirety. The weaker the hydrogen bonding between polymers, the smaller the number of hydrogen bonds which need to be dissociated for the film to dissolve and therefore film dissolution starts to happen at a lower pH value. Amongst the pH-degradable hydrogen-bonded systems reported so far, the PEO/PAA system is known to be one of the weakest, with a critical dissolution pH of 3.5. See, for example, DeLongchamp, D. M.; Hammond, P. T. Langmuir 2004, 20, 5403-5411, which is incorporated by reference in its entirety. It has also been observed for systems consisted of PEO that when PMAA was used as an alternative to PAA, pH_{crit} was shifted to a slightly higher pH value of 4.6. See, for example, Kharlampieva, E.; Sukhishvili, S. A. 2006, 46, 377-395, which is incorporated by reference in its entirety. Similar behavior was observed for the PVA_{Px}/PAA systems, though the pH_{crit}, is even lower than that of PEO/PAA. Kharlampieva and Sukhishvili monitored the film thickness by in situ IR and defined pH_{crit} as the maximum pH value for which less than 10% of film dissolved in one hour. See, for example, Kharlampieva, E.; Sukhishvili, S. A. 2006, 46, 377-395, which is incorporated by reference in its entirety. Similarly, the film is immersed in a pH-adjusted solution for 2 hr and measuring the film thickness before and after using profilometry. As shown in FIG. 20, (PVA_{P3}/PAA) multilayers start to dissolve between pH 2.5 and 3.0. This confirms that PVA/PAA multilayers are only weakly hydrogen bonded. This pH_{crit} value is one of the lowest reported for a stable, reproducible hydrogen bonded film.

For the PVA assembled with the stronger interacting polymer PMAA, the pH_{crit} shifts as predicted. However, whereas pH_{crit} increased by just 1.1 for PEO-based systems, here there is a dramatic increase of 3.75 pH units for PVA_{P3}/PMAA. As shown in FIG. 20, (PVA_{P3}/PMAA) has a significantly wider interval of stability than PVA_{P3}/PAA. This enhanced pH stability is attributed, at least in part, to the presence of the extra methyl group in PMAA which leads to a stronger hydrophobic interactions that stabilize the film. The drastic shift can be further explained by the contribution of relatively hydrophobic acetate moieties in the PVA. Previously, the pH stability of PMAA/poly(vinyl methyl ether) (PVME) and PMAA/PEO multilayers were compared to determine whether additional hydrophobic interactions contribute to the stabilization of hydrogen-bonded films. See, for example, Kharlampieva, E.; et al. Macromolecules 2005, 38, 10523-10531, which is incorporated by reference in its entirety. It was shown that the more numerous hydrocarbon moieties in the PVME chains resulted in a shift of pH_{crit} by about 1.6 compared to PMAA/PEO. Similarly, as shown in FIG. 20, (PVA_{P2}/PMAA) has a pH_{crit} of ˜4.5 whereas (PVA_{P3}/PMAA) has a pH_{crit} of ˜6.5. It can therefore be concluded that this shift is attributable to the additional hydrophobic contribution of acetate moieties in PVA. It is noteworthy that the degree of hydrolysis not only plays a role in terms of assembly but also acts as a parameter by which one can control the pH_{crit}.

The effect of PVA molecular weight on film disintegration was also tested to check for consistency with the literature. Although the molecular weight of the depositing polymer significantly affects the film growth behavior as shown in FIG. 18, it is generally accepted that if the films containing different molecular weights of PVA are equilibrated at each pH value, the same critical pH value is observed. See, for example, Kharlampieva, E.; Sukhishvili, S. A. 2006, 46, 377-395; Sukhishvili, S. A.; Granick, S. Macromolecules 2001, 35, 301-310; and Izumrudov, V. A.; Zhiryakova, M. V. Macromolecular Chemistry and Physics 1999, 200, 2533-2540, each of which is incorporated by reference in its entirety. Indeed, as shown in FIG. 21, the PVA_{P2}/PAA and PVA_{P3}/PAA show similar pH_{crit} values even though the film growth behavior is significantly different for these two systems. Dissociation of polymer segments is governed by the destruction of cooperative sequences of associating functional groups and with sufficient exposure to a solution of sufficiently low pH, the molecular weight has only a kinetic effect.

### Example 20

### Composition Analysis of pH-Triggered Release and Swelling Studies and Heat-Induced Esterification Using ¹H-NMR

Changing the pH stability of the system PVA_{P3}/PAA has interesting effects. This combination was chosen as the system of interest because of its intrinsically weak hydrogen bonding and thus extremely low pH_{crit}, value (˜2.75). Due to the fact that there are carboxylic acids and hydroxyl groups which are susceptible to esterification in the film, significant enhancement of pH stability with exposure to heat treatment was anticipated.

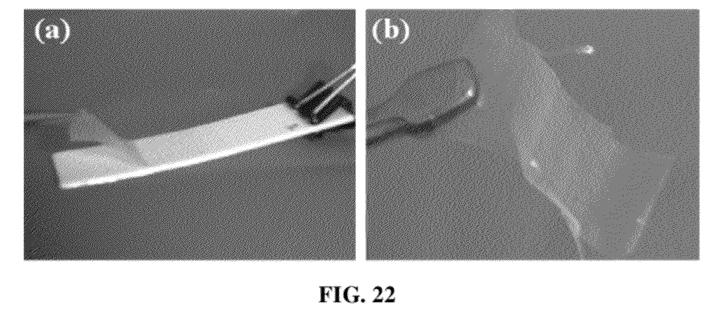

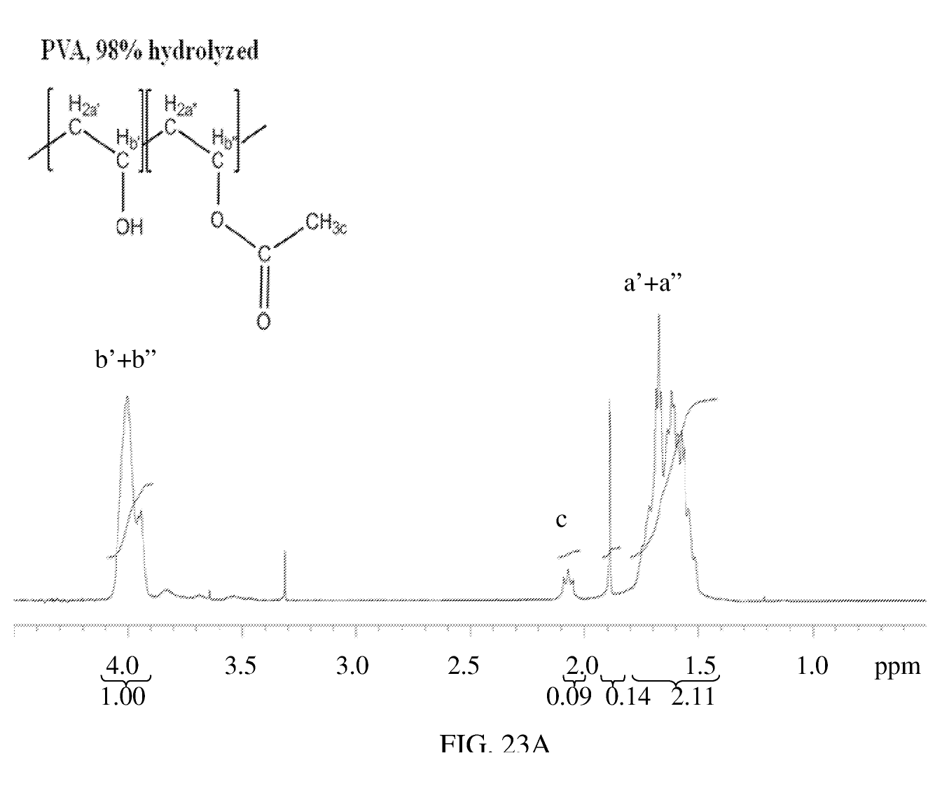

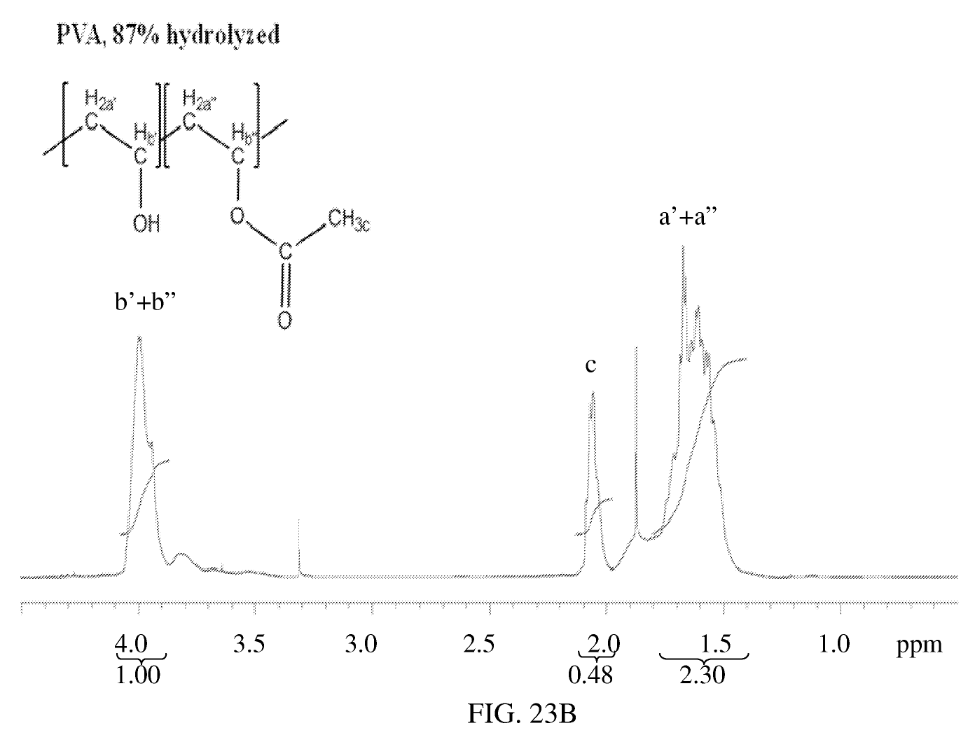

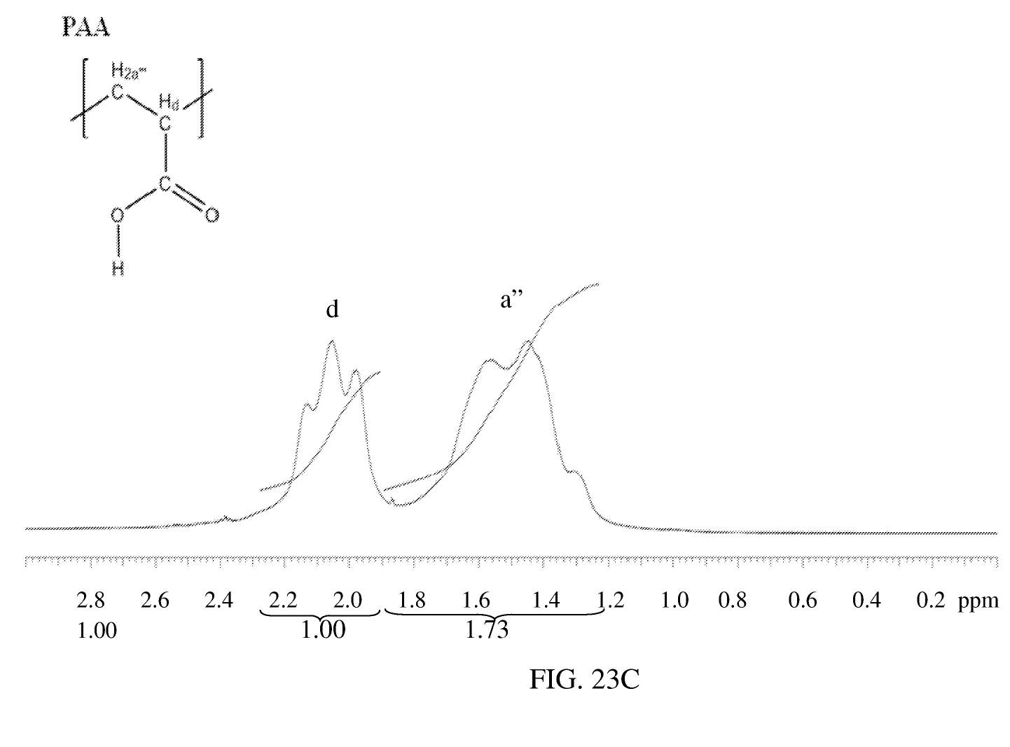

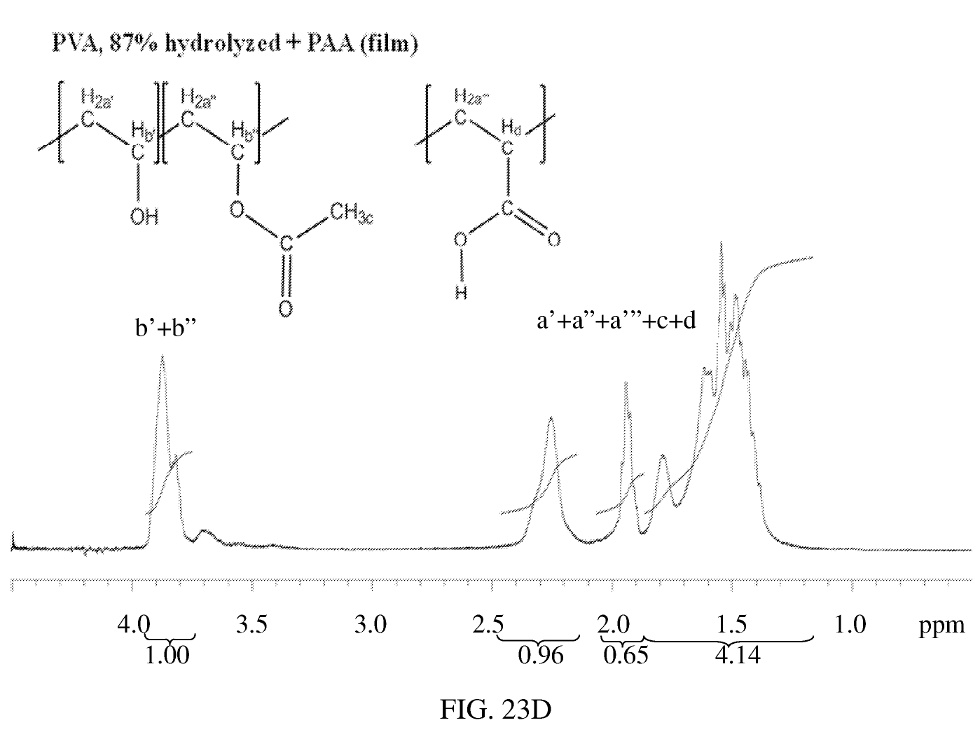

Prior to studying the heat-induced esterification of these multilayers and its effect on their pH stability, the composition of the (PVA_{P3}/PAA) system was thoroughly characterized. Free-standing films of (PVA_{P3}/PAA)₁₀₀ were deposited on Teflon substrates using a procedure reported previously to allow thermal characterization of the multilayer film. See FIG. 22 for pictures of the free-standing film and Teflon substrate. In a previous report, the Fox Equation, a mixing rule relating the glass transition temperature of a polymer composite to those of its constituent polymers was used to determine the composition of the film. See, for example, Lutkenhaus, J. L.; et al. Journal of the American Chemical Society 2005, 127, 17228-17234, which is incorporated by reference in its entirety. Due to the hygroscopic nature of the constituent polymers, residual water is present despite careful drying and is known to affect on the precise calculation of T_{g}. Thus to use differential scanning calorimetry (DSC) measurements in quantitative analysis, it is generally well accepted to acquire data from the second scan to get rid of water completely. For PVA and PAA, this becomes problematic for two reasons. First of all, the melting points of PVA and PAA³¹⁻³² (PVA: Tₘ=180˜230° C., PAA: Tₘ=210° C.) are close to or even higher than their thermal decomposition temperatures^{27,31} (PVA: T_{decompose}=140˜200° C., PAA: T_{decompose}=170° C.) and thus erasing the thermal history is impossible without compromising accuracy and reliability. Second, heating could result in the hydroxyl and carboxylic acid groups reacting to form an ester linkage, meaning the second scan might represent a completely different chemical nature. To overcome this problem which is rather specific to this system, an alternative method was used by dissolving the free-standing film in a deutrated solvent (D₂O) and characterizing it using NMR. The results of these experiments are given in FIG. 23. As a baseline, the degrees of hydrolysis for fully hydrolyzed and partially hydrolyzed PVA samples with similar molecular weight were determined. FIGS. 20A and 20B show the ¹H-NMR spectra of fully hydrolyzed and partially hydrolyzed PVA. The degree of hydrolysis was estimated by setting up a reference hydrogen atom peak that is distinguishable and present both in hydroxyl moiety and acetate moiety. Hydrogen atoms attached to the alpha carbon (H_{b′} and H_{b″}—peaks near 4.0 ppm) satisfy this criteria and therefore their peak area was set to 1.00. The peak area near 2.1 ppm which corresponds to the acetate hydrogen H_{c}, was then used to calculate the density of acetate groups in the overall chain. The data reveal that the fully hydrolyzed PVA sample has a degree of hydrolysis of 97% whereas the partially hydrolyzed PVA sample is 84% hydrolyzed, both of which agree well with the manufacturers' stated values.

Using the experimental calculations of degree of hydrolysis and the baseline PAA spectra as a reference, overall film composition was analyzed. A freestanding film of (PVA_{P3}/PAA)₁₀₀ was dissolved in D₂O and its spectra was taken. By once again normalizing with respect to the peaks associated with the hydrogen atoms on the alpha carbon (H_{b′} and H_{b″}) and subtracting out the contribution of PVA in the upfield region (1.0-2.5 ppm), the amount of each polymer within the film was calculated. These calculations showed that the film consisted of approximately 47% PVA and 53% PAA.

### Example 21

### Heat-Induced Esterification and its Effect on pH_{crit}

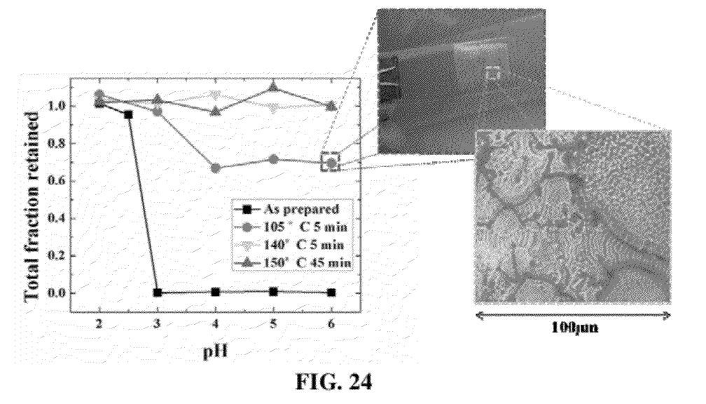

Several methods have been developed in the literature to extend the pH stability of hydrogen-bonded films to physiological conditions. See, for example, Kharlampieva, E.; Sukhishvili, S. A. 2006, 46, 377-395, which is incorporated by referenced in its entirety. These methods include blending hydrogen-bonded films with an electrostatically interacting pair, and cross-linking of the constituent polymers. See, for example, Cho, J.; Caruso, F. Macromolecules 2003, 36, 2845-2851; Kharlampieva, E.; Sukhishvili, S. A. Langmuir 2004, 20, 10712-10717; Yang, S. Y.; Rubner, M. F. Journal of the American Chemical Society 2002, 124, 2100-2101; and Yang, S. Y.; et al. Langmuir 2004, 20, 5978-5981, each of which is incorporated by reference in its entirety. A unique property of PVA with its hydroxyl groups is the fact that they can form ester linkages with PAA under relatively mild thermal treatment. In contrast to the PEO/PAA system where overnight heat treatment is required to induce anhydride linkages amongst only PAA, the PVA/PAA system results in pair wise cross-linking which confers enhanced stability even with relatively short heat treatment. See, for example, Lutkenhaus, J. L.; et al. Journal of the American Chemical Society 2005, 127, 17228-17234, which is incorporated by reference in its entirety. When heat treatment is required, one usually wants to avoid long term heating due to the many side reactions that may result in the loss of desired optical or chemical properties. FIG. 24 shows how pH stability varies with the extent of heat treatment for the PVA_{P3}/PAA system. In the results below, only the sample heated for 45 min at 150° C. under vacuum endured conditions extreme enough to start to turn yellow in color. As-prepared films had a pH_{crit} of ˜2.75 and dissolved completely upon exposure to pH 3.0 DI water. However, as the heat treatment temperature was increased above the T_{g} of the individual polymers (PVA T_{g}: 55-65° C., PAA T_{g}: 90-100° C.), enhancement of the films' pH stability was observed. See, for example, Lutkenhaus, J. L.; et al. Journal of the American Chemical Society 2005, 127, 17228-17234 and Marten, F. L. In Kirk-Othmer Encyclopedia of Chemical Technology; John Wiley & Sons, Inc.: 2000, each of which is incorporated by reference in its entirety. When the sample was subjected to 105° C. for 5 min, the film became more stable than the as-prepared films but due to insufficient time of heat treatment, the extent of esterification was not enough and/or not uniform throughout the film, resulting in partial rupture or dissolution of the film upon exposure to pH adjusted solution and drying. FIG. 24 shows a close up of a film heat treated at 105° C. for 5 min and then immersed in pH 6.0 DI water for 2 hrs. The film initially seemed intact but with time it swelled significantly and left bubble-like artifacts on the surface. As a control, two samples were heated for 5 min at 55° C. and 80° C. respectively and then immersed in pH 3.0 DI water to provide a lower bound on the temperature necessary to achieve cross-linking. These temperatures were chosen so that one refers to temperature below T_{g} of both polymers and the other as temperature above T_{g} of PVA. These films completely dissolved within a few minutes. On the other hand, for samples heated for 5 min at 140° C. and for 45 min at 150° C., the films were stable over a wide range of pH for at least 2 hr.

### Example 22

### FT-IR Analysis—Heat-Induced Esterification

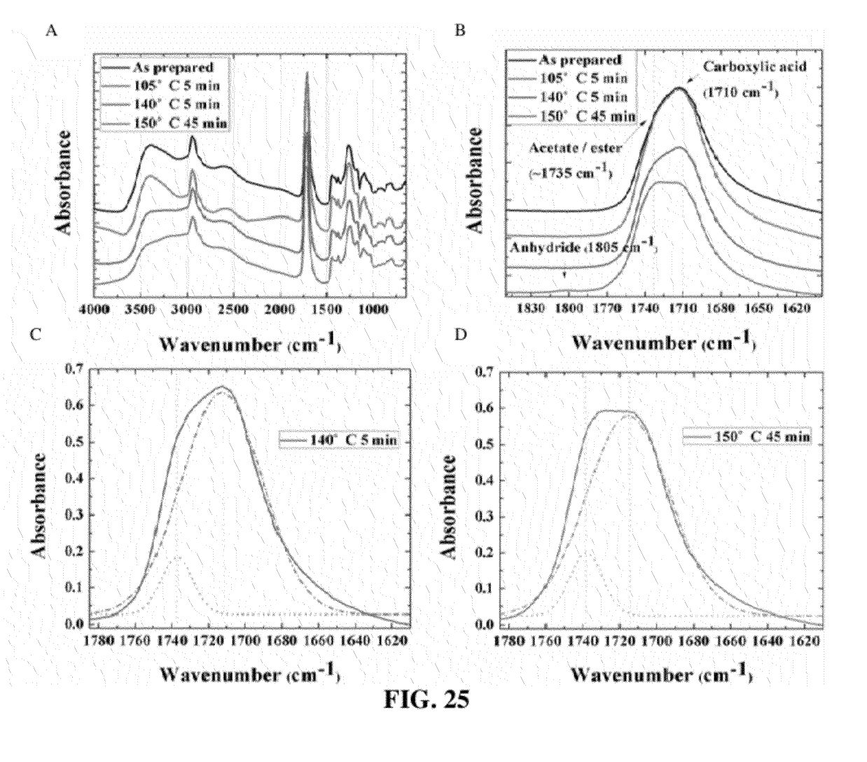

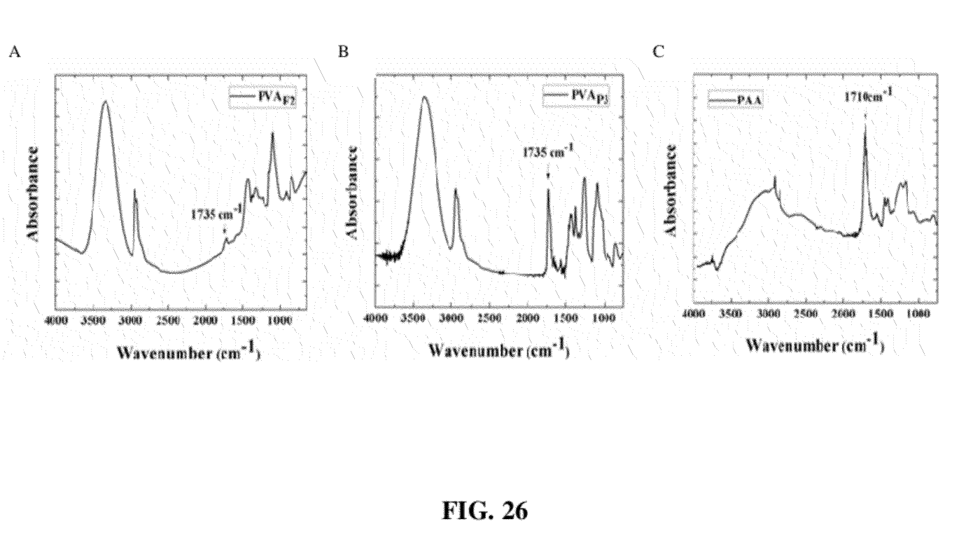

To further explore this stability enhancement and to confirm the effect of thermal treatment, PVA_{P3}/PAA films were prepared on ZnSe substrates and then subjected to different heat treatment protocols. FT-IR is a suitable technique for investigating molecular hydrogen-bonding interactions. See, for example, Chen, N.-x.; Zhang, J.-h. Chinese Journal of Polymer Science 2010, 28, 903-911, which is incorporated by reference in its entirety. FIG. 25A presents the FT-IR spectra of the various PVA_{P3}/PAA samples. The FT-IR spectra of the individual polymers are given in FIG. 26. It has been reported that a shift to lower wavenumbers and broadening of the hydroxyl peak are indications of it being in a hydrogen bonded state rather than in a free state. See, for example, Chen, N.-x.; Zhang, J.-h. Chinese Journal of Polymer Science 2010, 28, 903-911, which is incorporated by reference in its entirety. Typically, a strong hydroxyl peak at 3450-3600 cm⁻¹ is characteristic of unbonded hydroxyl groups and the peak for hydrogen-bonded hydroxyl groups is at 3200-3570 cm⁻¹. It is shown in FIG. 25A that, with increasingly severe heat treatment, the hydroxyl absorption band of the film slowly shifts and broadens, clearly indicating that hydrogen bonding between PVA and PAA is enhanced. Close ups of the carboxyl region in FIG. 25B-25D were examined in more depth to determine the effect of heating on the change in chemical nature. Protonated carboxylic acids typically have a peak at ˜1710 cm⁻¹ whereas acetate and ester peaks show up at ˜1735 cm⁻¹. As seen in FIG. 26B a shoulder appears even in the untreated sample due to the initial presence of acetate in PVA_{P3}. As the extent of heat treatment increases, it is clear that the acetate/ester:acid ratio in the overall carboxyl peak starts to increase. While the film heated for 5 min at 105° C. does not change significantly after the treatment, the films that were stable to high pH show dramatic changes in their acetate/ester/acid distribution. Interestingly, the anhydride peak at ˜1805 cm⁻¹ only becomes apparent when the sample was subjected to rather harsh conditions. Additionally, rough verification the extent of esterification within the film was attempted by fitting the peaks with Gaussian curves centered at two constant v values, one assigned to the protonated carboxylic acid (1710 cm⁻¹) and the other assigned to the acetate and ester (1735 cm⁻¹). Also anhydride peak centered at 1805 cm⁻¹ was considered for 150° C. 45 min heated sample. FIGS. 25C and 25D show the deconvoluted carbonyl peaks. The area ratio of the ester peak to that of the overall carbonyl peak (protonated carboxylic acid and ester) was 0.092 meaning that in the order of magnitude sense, 9% of the carboxylic acids group initially present was cross-linked to form ester bondages. Similarly, for the sample heated for 45 min at 150° C., 11% of carboxylic acid groups were esterified. In this case, small portion of anhydride peak was also considered for estimation.

### Example 23

### Effect of Solution pH on the Swelling of Various Heat-Treated Samples

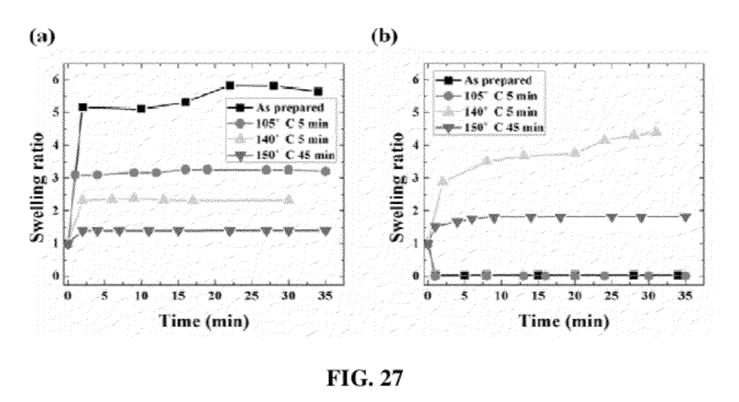

The pH-dependent swelling of multilayer films was monitored using in situ ellipsometry. For these experiments, all films were assembled at pH 2.0. The swelling ratio is defined here as the ratio of the thickness of a film in solution to that of a dry film measured via ellipsometry. FIG. 27A shows the swelling ratio in pH 2.0 DI water versus time for a series of (PVA_{P3}/PAA)₃₀ films subjected to a variety of heat treatment protocols. For the untreated sample, the swelling ratio was ˜5.5 and as the severity of the heat treatment increased, a decrease in swelling ratio was observed with the values of ˜3.2 for 105° C., ˜2.3 for 140° C., ˜1.4 for 150° C. This gradual decrease in swelling ratio is consistent with increased esterification which restrains the ability of the chains to swell by introducing cross-linking points. Comparing the swelling of (PVA_{P3}/PAA)₃₀ films subjected to different heat treatments in pH 7.4 phosphate buffer saline (PBS), it is evident from FIG. 27B that only those films heated for 5 min at 140° C. and for 45 min at 150° C. were stable at physiological pH. Interestingly, a comparison of the swelling ratio at the extremes of the pH range we investigated revealed that the swelling ratio of films treated for 45 min at 150° C. in pH 2.0 DI water and pH 7.4 PBS were ˜1.4 and ˜1.8 respectively. However for the film heated for 5 min at 140° C., a significant difference in swelling ratio was observed with a value of ˜2.3 for pH 2.0 DI water and a value of ˜4.3 for pH 7.4 PBS. Similar behavior was observed previously for a bicomponent hydrogel consisting of PVA and PAA prepared by solvent casting and heat treated to give pH-responsive hydrogels. See, for example, Vázquez-Tones, H.; et al. Journal of Applied Polymer Science 1993, 50, 777-792; Lee, Y. M.; et al. Journal of Applied Polymer Science 1996, 62, 301-311; and Jin, X.; Hsieh, Y.-L. Polymer 2005, 46, 5149-5160, each of which is incorporated by reference in its entirety. This drastic increase in swelling ratio could be explained by two factors. Firstly, in pH 2.0 DI water, the lower swelling ratio of the film heated for 45 min at 150° C. suggests that these films are held together by a tighter network of more dense ester bonds than the film treated for 5 min at 140° C. Secondly, the number of carboxylic acid groups in the film that have not been esterified is higher for the film treated for 5 min at 140° C. These groups ionize at high pH, resulting in an osmotic driving force which encourages diffusion of solvent into the film and thus raises the swelling ratio. It is clear, therefore, that the distribution of functional groups and cross-link density within the film have a profound effect on the films properties and on their ability to respond to external stimuli. The results show that a careful choice of heat treatment conditions renders the film quite sensitive to pH changes.

### Example 24

### Reversibility of pH-Triggered Swelling

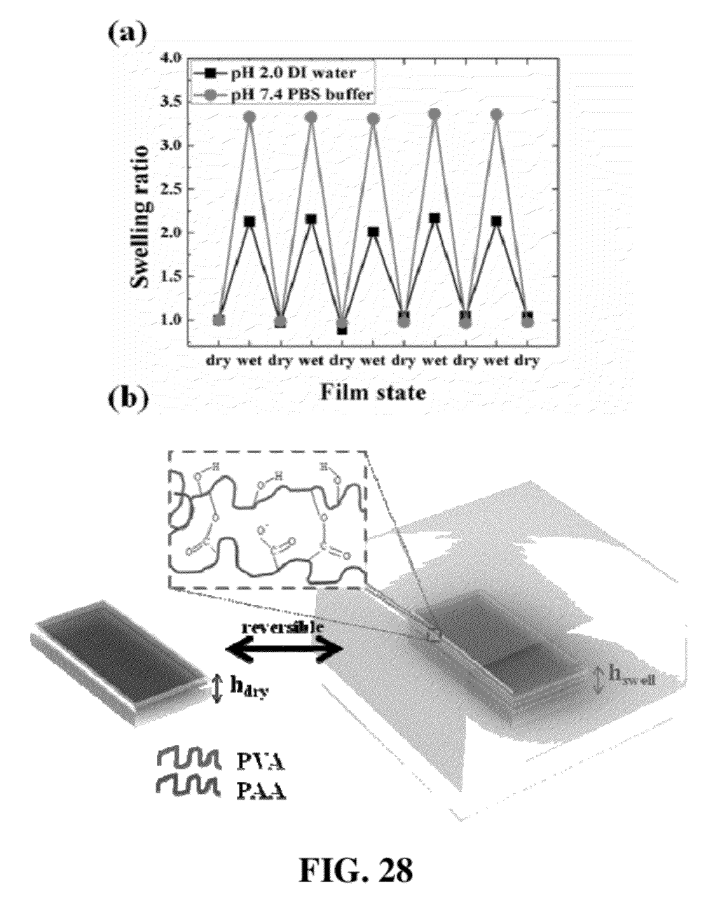

One of the major criteria for both pH stability and pH-responsive behavior is the response to repeated exposure. Here, the thickness of a (PVA_{P3}/PAA)₃₀ film heated for 5 min at 140° C. was monitored by in situ ellipsometry over five cycles of immersion in either pH 2.0 DI water or pH 7.4 PBS and then drying. Each film was immersed in solution for 10 minutes and dried with N₂ before measurements. FIG. 28A shows the reversible pH-dependent swelling behavior of a (PVA_{P3}/PAA)₃₀ film heated for 5 min at 140° C. Again the film showed swelling ratios of ˜2.3 for pH 2.0 DI water and ˜3.7 for pH 7.4 PBS, but these values were observed repeatedly over a series of five cycles. The thickness increases and decreases observed using in-situ ellipsometry were accompanied by commensurate decreases and increases of the refractive index, indicating that film loss was negligible. FIG. 28B is a schematic of the phenomena where partial ester bonds act as the covalent cross-linker and the ionized carboxylic acid groups and hydroxyl groups present inside the multilayer film contribute to this pH-responsive swelling behavior.

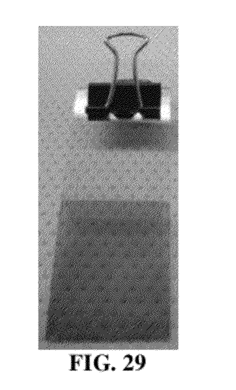

To provide further evidence for the hypothesis that osmotic pressure gradients due to ionized carboxylic acid groups affect the swelling of these films, qualitative methylene blue adsorption studies were performed to determine whether ionized carboxylic acids exist in the film. See, for example, Yoo, D.; Shiratori, S. S.; Rubner, M. F. Macromolecules 1998, 31, 4309-4318, which is incorporated by reference in its entirety. The procedure simply involved adsorbing positively charged methylene blue dye into the film and observing whether the film remained stained after thorough rinsing. FIG. 29 shows that a significant amount of ionized carboxylic acid is present in the film even after rigorous rinsing with PBS. Thus a thin, reversibly pH-responsive hydrogel can be fabricated with both hydroxyl groups and carboxylic acid groups available for further functionalization.

### Example 25

### Biofunctionalization with FITC-BSA and RB-PEG

A thin hydrogel with hydroxyl groups and carboxylic acid groups can be utilized to create a multifunctional coating by post-functionalization. Although the difference in reactivity between hydroxyl and carboxylic acid groups in aqueous environment is not significantly different in nature, the absence of amine groups from the initial film allows covalent attachment of two different molecules to the film by appropriate selection of target molecules and chemistries. The amount of target material attached can be controlled by adjusting the extent of esterification and thus the amount of free hydroxyl and carboxylic acid groups in the hydrogel.

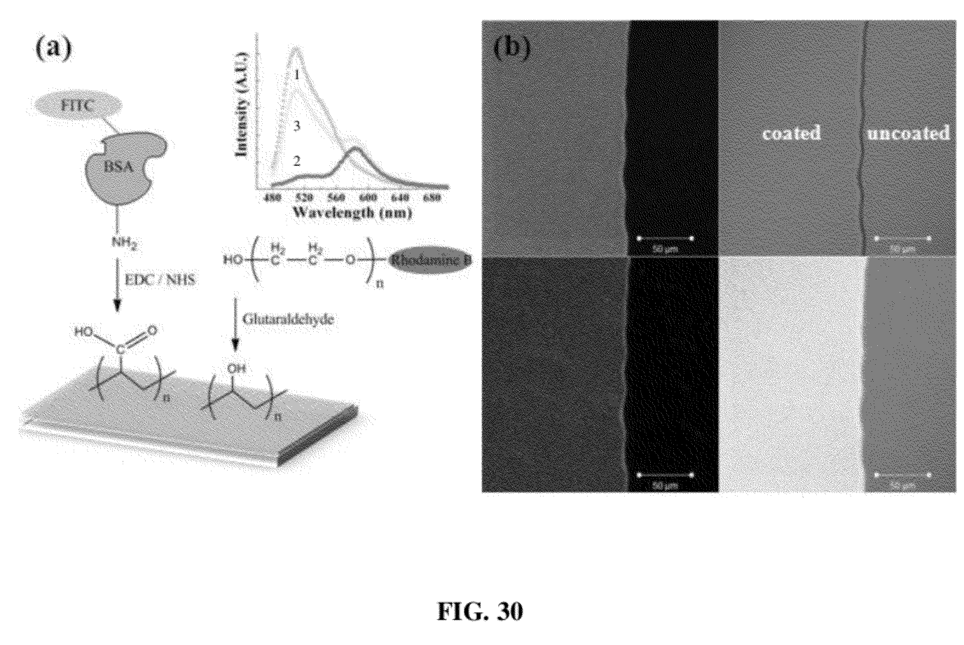

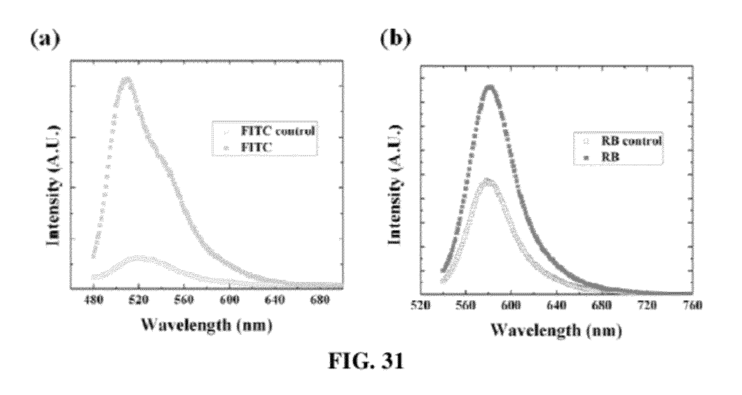

BSA labeled with FITC (FITC-BSA) and a common biocompatible polymer, PEG labeled with Rhodamine B (RB-PEG), were used as target molecules. As shown in FIG. 30A, the coating was first functionalized with FITC-BSA using carbodiimide chemistry. Carboxylic acid groups embedded in the film were first activated by EDC/NHS, and primary amine terminated FITC-BSA was covalently attached. To rule out the loosely (noncovalently) bound FITC-BSA, a control without the EDC/NHS treatment was performed (FIG. 31A). A comparison of emission spectra (excited at 440 nm) revealed that Tween-20 PBS was effective in terms of removing the non-covalently bound FITC-BSA.

After FITC-BSA attachment, the film was dip coated for 30 min in a 0.5 mg/mL RB-PEG solution. Then the film was soaked in a 30° C., 0.13% (w/w) glutaraldehyde in PBS solution for 10 min, rinsed with DI water, and dried. When the film was introduced to the 0.13% (w/w) glutaraldehyde PBS solution, not only did the RB-PEG react with the hydroxyl groups, but also the some of hydroxyl groups embedded in the system reacted with themselves. The net positive charge of Rhodamine B dye under physiological conditions allowed the RB-PEG to adsorb to the film. Even 15 hr exposure of the films to a Tween-20 solution removed roughly half of the non-covalently bound RB-PEG as shown in FIG. 31B. However, in case of films to which FITC-BSA had been attached, the number of free carboxylic acid groups available for electrostatic interaction was limited by the prior reaction with FITC-BSA.

As shown in FIG. 30, the (PVA/PAA) hydrogel was functionalized with two different biocompatible materials. The upper-right hand corner of FIG. 30A shows the emission spectra of three individual samples excited at a single wavelength of 440 nm (trace 1: FITC-BSA only; trace 2: RB-PEG only, trace 3: both), which confirmed that both materials were attached (trace 3 showing both emission peaks). FIG. 30B shows a confocal microscopy image of the film functionalized with both FITC-BSA and RB-PEG, which clearly revealed that both emissions arose from only the coated area.

### Example 26

### Spray Layer-by-Layer Assembly of PVA/PAA Multilayers

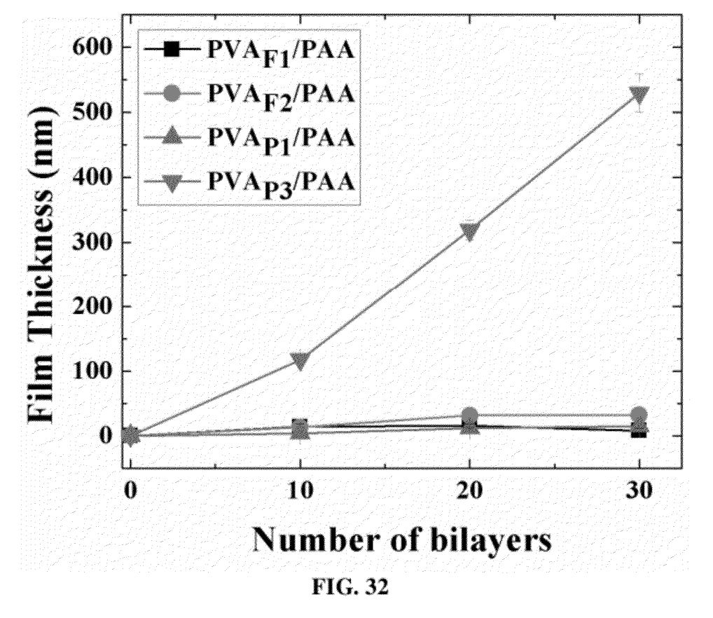

Although conventional LbL assembly is a relatively low-cost process involving deposition from aqueous solutions, the long times usually required to complete a multilayered coating can be less practical for large-area industrial applications. Spray-LbL can create multilayered coatings comparable in quality to conventional solution immersion techniques, but in less time. Hence, the PVA/PAA multilayer system can be prepared using Spray-LbL. Similar growth behavior was observed where the film growth behavior was dramatically dependent on the molecular weight and degree of hydrolysis. The general tendency observed, where only partially hydrolyzed PVA with high molecular weight showed significant growth behavior, was similar to the immersion technique (FIG. 32). However, (PVA_{P3}/PAA)₃₀ was approximately one third of its equivalent film prepared by conventional method. Nevertheless the overall quality of the film was comparable in uniformity but prepared in a significantly faster rate.

### Example 27

### Anti-Fogging Properties of PVA/PAA Multilayers

The glass substrates were degreased by sonication in a 4% (v/v) solution of Micro-90 (International Products Co.) for 15 min, and subsequently sonicated twice in DI water for 15 min and dried with compressed air. They were then treated with oxygen plasma (PDC-32G, Harrick Scientific Products, Inc.) for 2 min at 150 mTorr. A plasma-treated glass slide was immediately immersed in a 0.1% (w/v) PGMA/MEK solution for 20 sec and then placed in a 110° C. oven for 30 min to covalently bond PGMA to the substrate. After cooling to ambient temperature, the PGMA-coated glass substrate was immersed in a 1 mg/mL aqueous solution of PVA (M_{w}=131 000 g/mol, PDI=1.50, 87-89% hydrolyzed, pH 2.0) for 20 min. The PVA-coated substrate was then dried at ambient temperature and again placed in the oven at 110° C. for 30 min to induce a chemical reaction between the residual epoxy groups present in PGMA and the PVA hydroxyl groups. Subsequent layers of films were constructed using a Stratosequence VI spin dipper (Nanostrata Inc.) controlled using StratoSmart v6.2 software. Substrates were first rinsed three times using DI water of the same pH as the proceeding PVA solutions to remove unreacted PVA from the substrate. Layer-by-layer (LbL) assembly was then commenced with dipping times of 10 min for the polymer solutions, followed by three rinses of 2, 1, and 1 min. The concentration of the polymer solutions used was 1 mg/mL and the pH of these solutions and the rinse water were adjusted with 0.1 M HCl or 0.1 M NaOH. The nomenclature for LbL films follows the convention (“polycation”/“polyanion”)_{Z} where in our case, polycation and polyanion can be replaced by hydrogen bonding acceptor and donor respectively. Also Z is the total number of bilayers deposited.

The (PVA/PAA)₃₀ film is defined as an “as prepared” sample. All other samples were prepared starting out with this “as prepared” sample. The “(PVA/PAA)₃₀ x-linked” sample was prepared by heat treating the as prepared sample at 140° C. for 5 min in vacuum. The film was then immersed in a 0.13% glutaraldehyde (Sigma-Aldrich) PBS solution for 10 min preheated to 30° C. After the cross-linking, the film was thoroughly rinsed with DI water and dried with house compressed air. The “(PVA/PAA)₃₀ poly(ethylene glycol methyl ether) (PEG-OH) x-linked” sample was prepared similar to the (PVA/PAA)₃₀ x-linked sample except that in between the heat treatment and glutaraldehyde cross-linking, the film was immersed in a 10 mM PEG-OH (Sigma-Aldrich) solution for 30 min and dried in ambient conditions. This procedure allows PEG-OH to be covalently attached to hydroxyl groups in PVA during the glutaraldehyde cross-linking procedure. The “(PVA/PAA)₃₀ FSN-100 Zonyl-fluorinated polyethylene glycol (f-PEG-OH) x-linked” sample was prepared similar to the (PVA/PAA)₃₀ PEG-OH X-linked sample except that a 10 mM (Dupont) solution was used instead of the PEG-OH solution.

Each sample was challenged with the various anti-fog tests listed in Table 5. In all cases, uncoated glass control samples exhibited extensive fogging during testing. The as-prepared sample initially showed excellent anti-fogging properties, however, after multiple tests, the coating started to dissolve and the anti-fogging property was lost. The (PVA/PAA)₃₀ x-linked exhibited slight fogging behavior and hence was characterized as only a poor to good anti-fog system. In the case of coatings functionalized with either PEG-OH or f-PEG-OH, outstanding anti-fogging properties were observed in all the tests performed. In addition, cleaning the coating multiple times with an aggressive glass cleaner (windex) did not compromise the excellent anti-fog behavior.

TABLE 5
List of anti-fog tests performed on different coatings on glass substrate

| | Results | | | |
|---|---|---|---|---|
| | | | (PVA/ | (PVA/ |
| | Uncoated | (PVA/ | PAA)₃₀ | PAA)₃₀ |
| Anti-fog test | glass | PAA)₃₀ | PEG-OH | f-PEG-OH |
| description | (control) | X-linked | X-linked | X-linked |
| Freezer test^{a} | Extensively | Slightly | Excellent | Excellent |
| Windex-freezer | fogging | fogging | anti-fog | anti-fog |
| test^{b} | | | performance | performance |
| Freezer-humidity | | | | |
| chamber test^{c} | | | | |
| Boiling water | | | | |
| steam test^{d} | | | | |

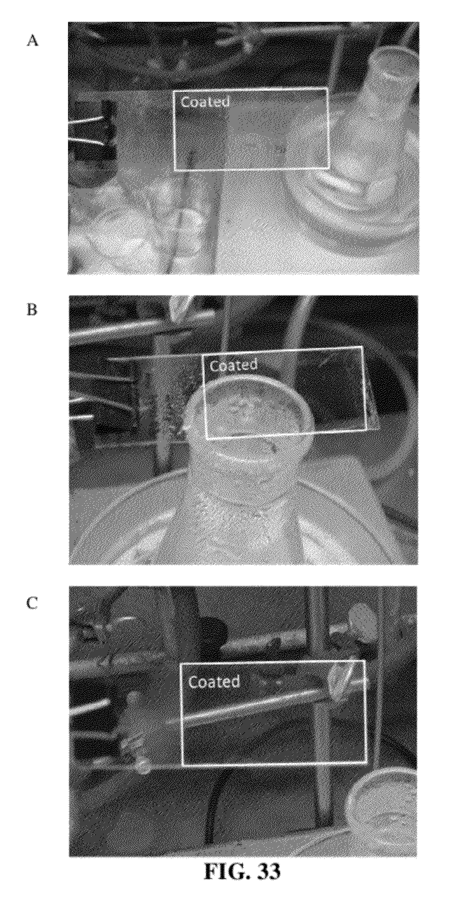

^{a}In this test, coatings were incubated in the freezer for 24 hrs and brought out to ambient conditions. Visual observation within a couple of seconds to 5 min after the sample was taken out of the freezer was used to determine whether the coating is fogging or not. An excellent rating means that no fogging was observed during this time interval. Samples were tested in this manner for at least one week.
^{b}Every procedure is the same as the freezer test except that the samples were cleaned with windex prior to placement in the freezer. Samples were tested in this manner for at least one week.
^{c}Similar to the freezer test except that the samples were introduced to a humidity chamber set at 37° C. and 80% RH instead of ambient conditions.
^{d}Coatings were evaluated by direct exposure to hot steam of boiling water. See FIGS. 33A-C.

Other embodiments are within the scope of the following claims.

What is claimed is:

1. A method of coating a surface of an article, comprising
depositing a composition including an anchoring polymer on a surface, and
depositing a first hydrophilic polymer and a second hydrophilic polymer on the composition including the anchoring polymer.

2. The method of claim 1, wherein depositing the composition including the anchoring polymer includes contacting the surface with a solution including the anchoring polymer.

3. The method of claim 2, further comprising exposing the surface, prior to depositing the first hydrophilic polymer or the second hydrophilic polymer, to a predetermined temperature for a predetermined time sufficient to thermally cross-link the surface and the anchoring polymer but insufficient to deform the article.

4. The method of claim 3, wherein cross-linking the surface and the anchoring polymer includes forming covalent bonds between the surface and the anchoring polymer.

5. The method of claim 3, wherein depositing the first hydrophilic polymer and the second hydrophilic polymer further includes contacting the surface with a solution including the first hydrophilic polymer.

6. The method of claim 5, wherein the solution including the first hydrophilic polymer is at a pH no higher than 2.0.

7. The method of claim 5, further comprising exposing the surface, after depositing the anchoring polymer and the first hydrophilic polymer, to a predetermined temperature for a predetermined time sufficient to thermally cross-link the anchoring polymer and the first hydrophilic polymer but insufficient to deform the article.

8. The method of claim 5, wherein depositing the first hydrophilic polymer and the second hydrophilic polymer further includes contacting the surface with a solution including the second hydrophilic polymer.

9. The method of claim 8, wherein depositing the composition including an anchoring polymer on a surface, and depositing the first hydrophilic polymer and the second hydrophilic polymer on the composition including the anchoring polymer includes forming an anchoring layer including the anchoring polymer, forming a first layer including the first hydrophilic polymer, and forming a second layer including the second hydrophilic polymer.

10. The method of claim 9, wherein depositing the first hydrophilic polymer and the second hydrophilic polymer includes selecting the first hydrophilic polymer and the second hydrophilic polymer such that the first hydrophilic polymer and the second hydrophilic polymer intermingle when deposited.

11. The method of claim 10, wherein depositing the first hydrophilic polymer and the second hydrophilic polymer includes forming an alternating sequence of layers including a plurality of first layers including the first hydrophilic polymer alternating with a plurality of second layers including the second hydrophilic polymer.

12. The method of claim 8, wherein depositing the first hydrophilic polymer and the second hydrophilic polymer includes alternately contacting the surface with the solution including the first hydrophilic polymer and with a solution including the second hydrophilic polymer.

13. The method of claim 1, wherein the anchoring polymer includes cross-linking groups.

14. The method of claim 13, wherein the cross-linking groups are selected from the group consisting of carboxyl, epoxy, isocyanate, acrylate, vinyl, and styryl.

15. The method of claim 14, wherein the anchoring polymer includes poly(glycidyl methacrylate) (PGMA).

16. The method of claim 1, wherein the first hydrophilic polymer includes a poly(vinyl alcohol) (PVA).

17. The method of claim 1, wherein the second hydrophilic polymer is selected from the group consisting of poly(acrylic acid)-co-poly(ethylene oxide) copolymer (PAA-co-PEG), a poly(methacrylic acid)-co-poly(ethylene oxide) copolymer (PMAA-co-PEG), a poly(acrylic acid)-co-poly(acrylamide) copolymer (PAA-co-PAAM), a poly(methacrylic acid)-co-poly(acrylamide) (PMAA-co-PAAM), poly(acrylic acid) (PAA), poly(methacrylic acid) (PMAA), and a combination thereof.

18. The method of claim 1, wherein the coating includes a plurality of carboxylic acid groups, a plurality of hydroxyl groups, or a combination thereof.

19. The method of claim 1, wherein the coating is biocompatible and anti-fogging.

20. The method of claim 1, further comprising attaching a functional compound to the first hydrophilic polymer or the second hydrophilic polymer.

21. An article comprising a coated surface, the coating comprising:
an anchoring layer in contact with the surface of the article, the anchoring layer including an anchoring polymer;
a first layer over the anchoring layer, the first layer including a first hydrophilic polymer; and
a second layer over the first layer, the second layer including a second hydrophilic polymer;
wherein the coating is insoluble at physiological pH.

22. The article of claim 21, wherein the first hydrophilic polymer and the second hydrophilic polymer are intermingled.

23. The article of claim 21, wherein the coating includes an alternating sequence of layers including a plurality of layers including the first hydrophilic polymer alternating with a plurality of layers including the second hydrophilic polymer.

24. The article of claim 21, wherein the anchoring polymer includes cross-linking groups.

25. The article of claim 24, wherein the cross-linking groups are selected from the group consisting of carboxyl, epoxy, isocyanate, acrylate, vinyl, and styryl.

26. The article of claim 25, wherein the first polymeric material includes poly(glycidyl methacrylate) (PGMA).

27. The article of claim 21, wherein the first hydrophilic polymer includes a poly(vinyl alcohol) (PVA).

28. The article of claim 21, wherein the second hydrophilic polymer is selected from the group consisting of a poly(acrylic acid)-co-poly(ethylene oxide) copolymer (PAA-co-PEG), a poly(methacrylic acid)-co-poly(ethylene oxide) copolymer (PMAA-co-PEG), a poly(acrylic acid)-co-poly(acrylamide) copolymer (PAA-co-PAAM), a poly(methacrylic acid)-co-poly(acrylamide) (PMAA-co-PAAM), poly(acrylic acid) (PAA), poly(methacrylic acid) (PMAA), and a combination thereof.

29. The article of claim 21, wherein the surface of the article and the anchoring polymer are thermally cross-linked to one another.

30. The article of claim 29, wherein the thermal cross-link includes covalent bonds between the surface of the article and the anchoring polymer.

31. The article of claim 21, wherein the anchoring polymer and the first hydrophilic polymer are thermally cross-linked to one another.

32. The article of claim 31, wherein the thermal cross-link includes covalent bonds between the anchoring polymer and the first hydrophilic polymer.

33. The article of claim 21, wherein the first hydrophilic polymer and the second hydrophilic polymer are thermally cross-linked to one another.

34. The article of claim 33, wherein the thermal cross-link includes ester linkages between the first hydrophilic polymer and the second hydrophilic polymer.

35. The article of claim 21, wherein the coating is biocompatible.

36. The article of claim 21, wherein the coating is anti-fogging.

37. The article of claim 21, wherein the coating exhibits reversible pH-dependent swelling behavior.

38. The article of claim 21, wherein the first hydrophilic polymer and the second hydrophilic polymer comprise a plurality of carboxylic acid groups, a plurality of hydroxyl groups, or a combination thereof.

39. The article of claim 21, further comprising a functional compound attached to the first hydrophilic polymer or the second hydrophilic polymer.
